(19) United States
(12) Patent Application Publication
(10) Pub. No.: US 2004/0077395 A1
(43) Pub. Date: Apr. 22, 2004

(54) Gaming system for extended player retention

(76) Inventors: Roger Tuhy, Billings, MT (US); Jon L. Dehler, Billings, MT (US); Kit M. Seaton, Billings, MT (US); Jeffrey S. Sandridge, Billings, MT (US)

Correspondence Address: Anderson & Morishita, L.L.C., Suite 102, 2725 S. Jones Blvd., Las Vegas, NV, 89146, US

(21) Appl. No.: 10/651,870

(22) Filed: Aug. 29, 2003

(30) Foreign Application Priority Data
May 29, 2001 (WO) PCT/US01/17419

(51) Int. Cl. A63F 13/00

(52) U.S. Cl. 463/13

(57) ABSTRACT

A system for extended player retention provides for game designs and devices, and even methods of play, that present jackpot events for a player which may never be lost or taken from them, which may include a display (3) decrementing the distance that the player is from the jackpot event, which may be based upon common events intrinsically included in the game, which may utilize a number of events for card and other types of games, and which even may provide for multiple jackpots in which the player is constantly presented with a seemingly achievable distances at all times. The system may involve devices or methods which can be accomplished through human interaction or through devices. Each is designed to achieve extended player retention in specific games. Differing types of jackpot occurrences can be seen by the player as progressing toward the final jackpot payout. In addition, the system can present games in which the player is constantly afforded a not-too-distant jackpot event.

### I. TECHNICAL FIELD

Generally this invention relates to the gaming field, that is the industry providing gambling opportunities for adults. Specifically, the invention focuses upon the segment of that industry which develops or provides games either in a live format or through machines configured to present gaming opportunities to patrons. The invention focuses upon designing or providing games which the player finds sufficiently enjoyable so as to continue to play the game for a longer period of time. It presents not only specific games, but entire gaming paradigms which entice the player to continue or at least play the game for a longer period of time. Since gaming profits can to some degree be viewed as a function of the amount of player time spent on a machine or at a game, the invention can afford the game operator or casino higher per player profits.

### II. BACKGROUND

The gaming industry is a fascinating field with a number of unique attributes. Unlike many other industries in which products or services are produced and provided based on a more simple cost-benefit perspective, gaming has evolved from a number of very different perspectives. First, the games themselves are designed to present to players an opportunity for great rewards with little investment. Even though probabilities may dictate otherwise, games are often presented with extremely large potential winnings so as to entice players to participate. In addition, ancillary benefits—such as free food and free drinks—are frequently provided in order to entice players to both initially participate and to extend their participation in the particular games offered. The extent to which casinos or more generally game operators may go to entice players is perhaps most amazingly indicated by the lavish infrastructures often created in order to lure potential players. Immense structures imitating wonders of the world or the like, such as the Taj Mahal or even great pyramids, are testaments to the fact that operators have clearly focused upon subjective and even aesthetic criteria in their attempts to obtain patrons and, of course, enhance profits.

While the grandiosity of such gaming establishments may make great headlines and photo opportunities, it is to some degree surprising that the more fundamental aspect of the player's involvement in individual games has not received attention to this degree of notoriety. This is not to say that no others have recognized the importance of enticing the player to continue to participate in the particular game selected once their participation has begun. It is simply to say that the degree of attention devoted to this perhaps more mundane aspect is not comparable to the attention afforded the magnificence of the structures often surrounding that game.

Of course, it may be easily appreciated that the casino's profits can be highly influenced not only by the size of the individual bets players choose to make but also by the amount of time that the player participates in the game. To some degree, casino profits may even be measured by the average player time at a particular game. Since the supporting infrastructure whether it be personnel, electronic games themselves, or even the facility housing all the events, can be considered in one model a fixed cost, expanded player retention can represent a direct impact on the casino's bottom line. While of course the average amount of time a player participates in a particular game varies from player to player, the statistics can present an average player retention time. Any extension in this average retention time can thus have profound impacts on the profitability of the casino. It may also be a measure of the amount of entertainment the player experiences in their gaming participation.

It of course has been known to provide to players an extraordinary winning event, often called a jackpot. Jackpots are often configured to present an extremely high winning opportunity to a player. They may even include any type of enhanced winning opportunity beyond the typically main purpose or immediate objective of the game. Of course, simple economics may dictate that such extremely high winning events may also be extremely improbable in their occurrence. For this reason, players who either consider themselves unlucky or who take a more probabilistic approach to gaming may not be enticed by such opportunities. Since such players often have no way of knowing when the jackpot event might occur, the typical amount of time that these types of players might spend at a game is usually not influenced by this traditional type of jackpot event. Thus such jackpots may not typically be within the continued play tolerance for the player. The unpredictability or improbability of this type of a jackpot may not meet the typical player's continued play tolerance.

Others have however tried to address altering jackpots in a variety of ways. For, instance, in U.S. Pat. No. 5,586,766 to Forte, presents a jackpot event designed around consecutive card draws such as three “naturals” in the game of blackjack. Again, however, such events are fairly improbable and their very consecutive nature makes the player not view the event as anything other than a higher jackpot event for a relatively improbable occurrence. Rare occurrence jackpots such as disclosed in U.S. Pat. No. 5,851,147 to Stupak often do not retain the player. Secret jackpots such as is disclosed in one embodiment of U.S. Pat. No. 5,564,700 to Celona can also not achieve the desired purpose of this invention. In yet another approach, such as that of U.S. Pat. No. 5,487,547 to Hobert there is disclosed a design which is the product of an effort to provide a jackpot based on multiple rollings of particular numbers in a craps game. No only is this type of event not designed for a card game, it also does not provide for the type of presentation to the player so as to greatly influence their tolerance for continued play of that particular game. Since player retention is a goal, it must not only be presented but also perceived by the player so as to entice the player to continue playing the game beyond that statistically typical.

The present invention provides a way and even game paradigms for retaining players in particular gaming events. In this manner the invention takes a different direction from the one usually taken by those skilled in the art. Instead of taking the approach of providing a larger jackpot amount or otherwise altering the jackpot event, the invention considers this as a direction away from the perspective pursued to achieve extended player retention. Perhaps surprisingly while there has been a long felt need to achieve retention of the players participating, and perhaps surprisingly while the implementing arts and elements have long been available to achieve the direction that the present invention goes, those skilled in the art had perhaps not fully appreciated that the nature of the problem. They may have even been preconditioned to some degree by the directions others had taken in enticing players.

To the extent the efforts taken by others are considered substantial, perhaps even to the extent that billions of dollars have been spent on infrastructure, it can be seen that those desiring to entice players may have even simply failed to understand the nature of the problem and the impact of the game itself on player retention. It is even possible that the results of the present invention might be considered to some degree unexpected. The prior perspectives or even the approach previously taken might cause those to view the present invention with disbelief or incredulity. This may be especially true of those involved in pursuing the traditional approaches.

To some extent the attempts by others may have been inadequate because they failed to see the true nature of the problem or because they failed to address real commercial needs involved from this perspective. Perhaps also surprising is the fact that the present invention achieves its objectives with an unexpected degree of simplicity. This may represent not just a gradual improvement over prior art attempts but rather the presentation of new approaches which may be viewed as or may prove critical in achieving extended player retention. As each of the various independent claims and the discussion surrounding those elements shows, these potentially critical limitations may represent a host of different perspectives. Thus, the present invention represents not just the mere exercise of ordinary skill in varying gaming designs, but rather entirely different approaches to the player's experience.

### III. DISCLOSURE OF INVENTION

Accordingly, the present invention provides for game designs and devices, and even methods of play, that present jackpot events for a player which may never be lost or taken from them, which may include a display decrementing the distance that the player is from the jackpot event, which may be based upon common events intrinsically included in the game, which may utilize a number of events for card and other types of games, and which even may provide for multiple jackpots in which the player is constantly presented with a seemingly achievable distances at all times.

Thus a general object of the invention is to achieve extended player retention in specific games and in any gaming environment. In keeping with this general object, goals of embodiments of the invention may include presenting differing types of jackpots to a player in which the player does not merely perceive the jackpot as a random somewhat improbable event but rather can see progress toward the jackpot. In addition, a goal can be to present games in which the player is constantly enticed with a not-too-distant jackpot event.

Naturally, further goals and objects of the invention are disclosed throughout other areas of the specification and claims.

### IV. BRIEF DESCRIPTION OF DRAWINGS

FIG. 1 presents a representative illustration of one type of player presentation according to one embodiment of the invention.

FIG. 2 presents a conceptual illustration of the gaming interactions elements in a general sense.

FIG. 3 presents a conceptual illustration of a repetitive-event embodiment of the present invention.

FIG. 4 presents a conceptual illustration of a jackpot decrementer embodiment of the present invention.

FIG. 5 presents a conceptual illustration of a jackpot reset embodiment of the present invention.

FIG. 6 presents, an expanded display according to one poker embodiment of the present invention.

FIG. 7 presents an expanded display according to one Keno embodiment of the present invention.

FIG. 8 presents a representative illustration of one type of Keno device according to a Keno embodiment of the invention.

### V. MODES FOR CARRYING OUT THE INVENTION

As can be easily understood, the basic concepts of the present invention may be embodied in a variety of ways. The invention involves both methods and devices to accomplish the appropriate method. In this patent, the methods are disclosed both separately and as part of the results shown to be achieved by the various devices described. Importantly, all of these facets should be understood to be encompassed by this disclosure.

As mentioned earlier, the invention is founded upon a variety of particular game processes. These can include card based games such as poker or the like and may also include other types of games such as keno or the like. Perhaps of initial importance is the possibility of utilizing the present invention in a slot machine context where the player is presented with a slots game. As can be easily understood by those involved in the gaming field, slot machines may present individual events or may even present a card game of some type. Poker may of course be played on a slot machine. Slot machines themselves are also of initial interest to the present invention because they are often electronically configured devices. Whether involving a video display or mere electronic control of a more mechanical display, the slot machine may involve a base game generator which electronically controls outcomes and randomly generates events. The slot machine may also present a card game process as can be easily understood.

Regardless of the type of gaming event selected whether it be electronic, machine oriented, or a gaming event presented by real live human operators, the gaming events may be designed to provide a particular game process, whatever it may be, to a player so that the player may involve themselves in the game and act to achieve various outcomes. By utilizing varying gaming events the player can act in a manner responsive to a game generator through some type of player interaction element.

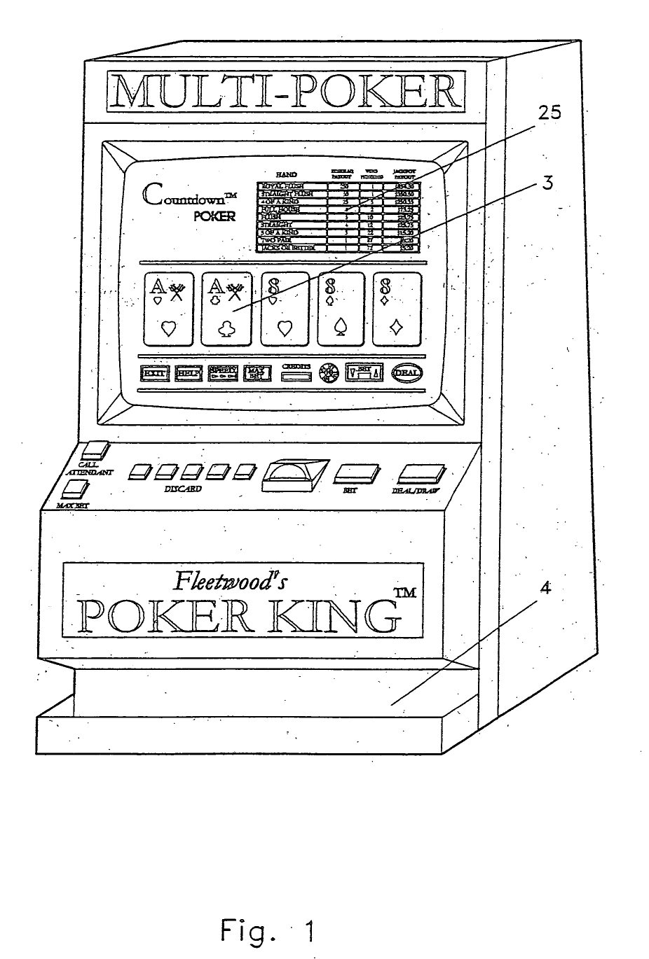

As those skilled in the art may easily appreciate, the games themselves may be generated by software and so many of the various elements involved may actually be subroutines or other portions of software coding presented to a programmable computing device. Thus the interconnections shown should be understood as illustrative and for conceptual purposes only. They should not be viewed as limiting as pure hardwiring or mechanical interconnection may not be necessary. Regardless of the configuration, however, the general game may be presented to the player through a great variety of displays including but not limited to a type of slot machine and display as indicated in FIG. 1.

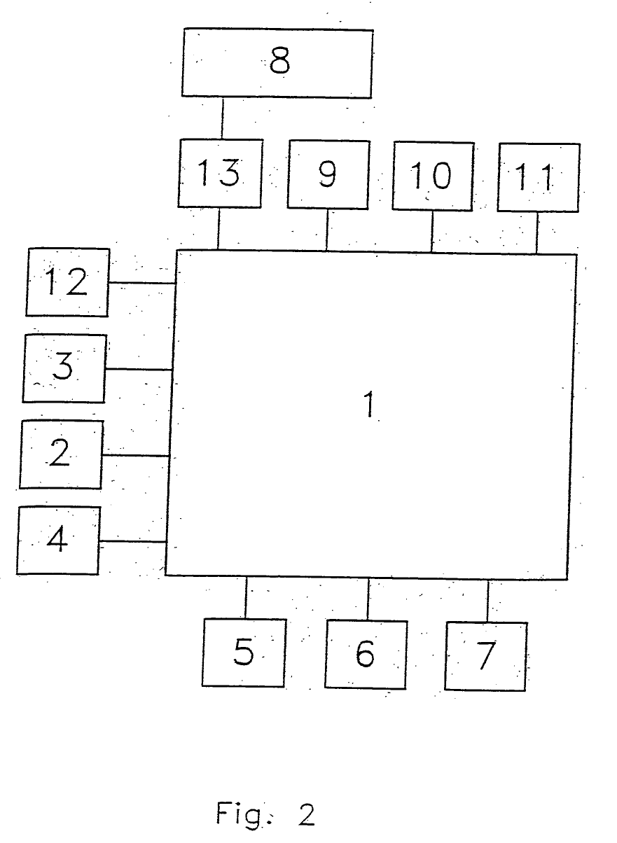

The entire player interaction in a general sense may be conceptually illustrated as shown in FIG. 2. As can be seen in FIG. 2, the game device may include a game generator (1) which may be a mechanical, electronic or other type of device such as portions of software code designed to generate a particular game process be it a card game, a keno game, or the like.

The game generator (1) may provide an opportunity to play a game and may be responsive to a player interaction element (2) through which the player may interact or involve themselves in some fashion with the game. The player interaction element (2) may of course represent buttons, touch screens, machine levers, money input, or even a board or table or the like. Importantly, however, the game generator (1) (which may be also nothing other than human interactions) may be responsive to input of the player interaction element (2).

Throughout this disclosure, it should be understood that in using the term “responsive”, the broadest sense is intended. There may be intervening elements or translational components but in general all that is necessary is that the change or occurrence within one element achieves—either directly or indirectly—a change or occurrence within another element in order to be “responsive”.

As in typical electronic gaming and other events, the game itself or merely some aspect relative to it may be presented to the player through some type of display (3). As mentioned earlier, the display (3) may be a mechanical display, human interaction, a board, cards, or even a video display among other possibilities. The salient aspect of the display (3) is simply that it present some information to the player in some form.

Obviously, the enticement of any game is the potential of some sort of payout upon placement of a bet. To provide for a payout, the gaming device as shown in FIG. 2 can conceptually present some type of payout element (4). Furthermore, the game may be designed to be easily re-instituted or re-initiated. For this purpose the game may include a game initiator (5), a game conclusion element (6), and maybe even most importantly a game re-initiator (7). Each of these need not be separate elements and even be thought of as being present as part of the game generator (1).

Either beyond merely routine play or as part of it, the system itself may include some sort of jackpot event for the player. In such an arrangement, the game may be considered to include some type of jackpot event standard element (8) which may serve to establish the standard against which achievement of the jackpot is determined. Whether human memory or an electronic feature, upon the achievement of the particular jackpot event, the system may include a jackpot payout element. This may be configured to include payout to the payout element (4). Depending upon the type of jackpot event selected, there may be a jackpot reset (9) which serves to begin anew the process of determining the achievement of a jackpot. In at least one embodiments of the present invention, this can be important because the jackpot may be a jackpot which carries over from one game to the other. Thus, a system may include a jackpot carryover (10). Again, depending upon the type of jackpot selected, there may even be included an event counter (11) which can be used to determine the achievement of the particular jackpot event provided by the jackpot event standard element (8). In at least one embodiment of the present invention, the system may include a jackpot status display (12) from which a player can constantly or at least periodically determine their status with respect to the selected jackpot event.

A complete gaming event may be of a type designed to be repetitively presented to a player. Thus, an individual game may be both instituted and concluded in an embodiment of the current system. The entire system may provide a repetitively re-instituted game process whereby another individual game or gaming event can automatically (or through player interaction) be caused to re-institute. In this fashion the game generator (1) may include or be considered as a repetitive game generator. Upon concluding the individual game, it may be possible that another individual game is re-instituted even as part of the particular game process.

Although common to present jackpots to players, it is sometimes less common to establish a jackpot event which is intrinsically is part of the game. Often it is necessary for a player to place a separate bet in order to participate in a jackpot round. This can have the problems mentioned earlier. In one embodiment of the invention, the jackpot may be intrinsically associated with the game such that upon playing the game, the jackpot is automatically associated with the game and intrinsically presented to the player. The jackpot can also be always available as part of the interaction in the game. Thus, the system may include an intrinsic jackpot association element or even an automatic jackpot association element (13) as shown in FIG. 2. The jackpot may thus be automatically associated with the game and may even be included as part of an initial play element such as may be included through the game initiator (5). Naturally, both the jackpot association element and the game initiator or initial play element may be automatically triggered such that upon the conclusion of the play, another game (or at least an initial screen to provide for another game) is automatically initiated.

As mentioned earlier, jackpots are traditionally associated with relatively improbable events. While the traditional thinking may be that this may make sense for economic reasons, as the present invention shows, it may be sub-optimal from the perspective of retaining players on a particular machine or in a particular process. In one embodiment, the present invention presents jackpot events which are based upon relatively common occurrences. In this fashion, the player can perceive the jackpot as more achievable, can perceive progress toward it, or can even perceive it as more likely to occur. The player may affirmatively perceive progress toward the ultimate jackpot.

Individual common events may not necessitate an immediate jackpot payout. Instead, the common occurrence jackpot event may merely be based upon a relatively common event. By relatively common event, it is meant that at least one of the individual events making up the overall common occurrence jackpot event may occur frequently enough to maintain the player's interest in continued play and even to expand the time that they would continue to play the game. In this fashion, either the jackpot event standards element (8) or the game generator (1) may be configured to establish at least one common-occurrence jackpot event. Thus, jackpot event standards element (8) may be configured to actually be a common-occurrence jackpot standards element.

In one embodiment of a system using a common-occurrence jackpot event, the occurrence may be selected as one having relatively high probability of occurrence. This may be defined in absolute terms or in terms of specific events to existing games. For instance, in a specific game refinement, the common-occurrence jackpot event may be based upon occurrences such as those listed for card games presented in Table 1. Naturally these should be viewed as representative only; in keeping with the broad coverage intended, other possibilities may be developed or may exist.

TABLE 1
OCCURRENCES FOR A HAND-
BASED TYPE OF POKER-
ORIENTED COMMON-
OCCURRENCE JACKPOT EVENT
straight game event
flush game event
full house game event
three-of-a-kind game event
two pair game event
jacks-or-better game event
queens-or-better game event
kings-or-better game event
aces-or-better game event
losing game event

### Sample Source Occurrences for a Hand-Based Type of Poker-Oriented Common-Occurrence Jackpot Event

Similarly, in the refinement of a common-occurrence jackpot event based upon a numerical analysis, the jackpot event may be selected from events having probabilities of greater than numbers such as presented in Table 2. There may even be a jackpot for every single hand. Again, naturally these should be viewed as representative only; in keeping with the broad coverage intended, other possibilities may be developed or may exist.

TABLE 2
A PROBABILITY-BASED TYPE OF POKER-ORIENTED COMMON-
OCCURRENCE JACKPOT EVENT
game events having a probability of greater than about 100 in 10,000
game events having a probability of greater than about 110 in 10,000
game events having a probability of greater than about 130 in 10,000
game events having a probability of greater than about 220 in 10,000
game events having a probability of greater than about 550 in 10,000
game events having a probability of greater than about 700 in 10,000
game events having a probability of greater than about 1200 in 10,000
game events having a probability of greater than about 2000 in 10,000
game events having a probability of greater than about 5000 in 10,000

### Sample Source Occurrences for a Probability-Based Type of Poker-Oriented Common-Occurrence Jackpot Event

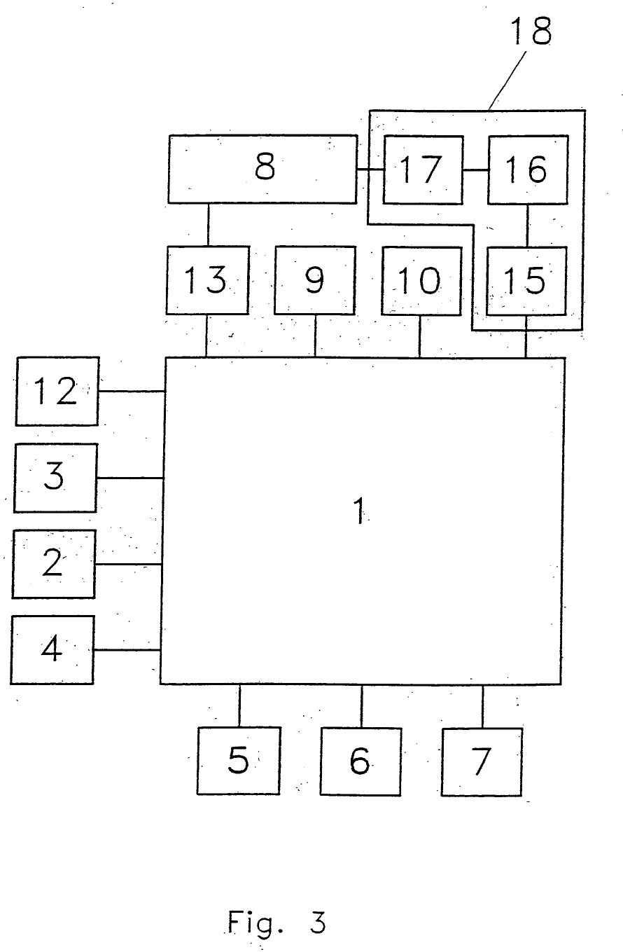

Of course, in order to achieve the appropriate payout, (as distinct from achieving extended player retention) the jackpot may be configured as a number of multiple events. This type of configuration may even be specific to card games such as poker or even games such as keno. Under this type of embodiment, the system may present repetitive events such as a number of occurrences of a particular event. For example, utilizing one of the type of events shown in Table 1, the system may be configured to pay a jackpot amount upon the occurrence of 20 full house game events. In this fashion the player can understand that each full house they achieve makes them that much closer to a particular jackpot payout. A conceptual illustration of a system according to this type of game paradigm is illustrated in FIG. 3.

In FIG. 3, it can be seen that it is possible to configure a system to replace or include as part of the event counter (11) a multiple event tracker (15). This multiple event racker (15) may thus respond to or inversely influence the actions of a comparator (16) which may serve to compare the events tracked against either the jackpot event standards element (8) or even some separately included event memory element (17).

Throughout this disclosure, it again should be understood that in defining the various elements involved, since many of the elements can be configured in a host of different ways, the actual names used and even the replacement of one element by another may not signal any difference in operation of the particular element. This is particularly true since the system may be software based and various lines of code may actually be used to provide the element desired. Configurations using the above type of embodiment may range from systems utilizing the events counter (11) as being directly responsive to the jackpot standards element (8) or may employ other configurations. As explained, separate elements may or may not be physically or conceptually present. Importantly, even though the various elements might be individually called out, if the system achieves the result described or accomplishes the purposes mentioned, they may be considered as presenting that type of an element. For instance, in the more simplified design in which event counter (11) is configured to be directly responsive to jackpot event standards element (8), it would be understood that jackpot event standards element (8) could actually provide an event memory element such as event memory element (17) illustrated separately. Similarly, the counter or the standards element may serve as providing a comparator (16) as again separately illustrated. This type of alternative configuration and variation in element names should be understood as encompassed by the description throughout the entire disclosure.

The system may employ a multiple event occurrence as the basis for a jackpot event. Multiple event occurrences may be selected or configured in a variety of different ways. Of course, it may be simply a repetitive event. It may also be a non-consecutive event. This can be significant because it can alter the player's perception of the likelihood of achieving the event. For example, players regularly recognize that it is unlikely that they will achieve three full houses in a row, however, they may recognize or at least perceive (even if only subconsciously) that they may be able to achieve 20 full houses given an significant amount of time to play the game. This can be a basis for expanding players' retention in the game process. They may even achieve a satisfaction by having achieved a jackpot. By using repetitive events which are either identical or perhaps at least similar, the multiple event tracker (15) illustrated in FIG. 3 may actually serve as a similar game occurrence tracker. Furthermore, the event counter (11) or perhaps even the multiple event tracker (15) may be automatic so as to present an automatic event counter. Thus, they may serve to track each happening of a particular game occurrence qualifying for a repetitive occurrence jackpot. In this fashion the game can present to the player the opportunity of achieving or obtaining a jackpot occurrence by simply accomplishing a plurality of a repetitive occurrence jackpot events. These of course may be automatically counted for a variety of different game events.

The jackpot event standards element (8) may even be configured so as to present a high event occurrence number jackpot event element. In this type of an embodiment of the present invention, the invention may utilize the realization that continued progress toward a goal may be very important in retaining the player in the game process. By using a high event occurrence number, that is a number which presents to the player an opportunity for relatively frequent progress toward the ultimate goal, the invention may help present a game to the player which may retain the player for a longer period of time. In a refinement of the type of high event occurrence number envisioned, jackpot events may be selected from numbers such as those indicated in Table 3. Upon the player achieving such high number of events, the player may actually attain the jackpot goal and achieve the jackpot payout. Again, naturally these should be viewed as representative only; in keeping with the broad coverage intended, other possibilities may be developed or may exist.

TABLE 3
HIGH EVENT OCCURRENCE NUMBERS
at least about 2 non-consecutive game event occurrences
at least about 5 non-consecutive game event occurrences
at least about 5 game event occurrences
at least about 10 game event occurrences
at least about 20 game event occurrences
at least about 40 game event occurrences
at least about 50 game event occurrences
at least about 60 game event occurrences
at least about 80 game event occurrences
at least about 100 game event occurrences

### Sample High Event Occurrence Numbers for One Type of System

It may be important in certain embodiments to automatically count each of the relevant occurrences for the player. While of course it is possible for the player to keep track of the number themselves, the very purpose of the invention, namely, achieving extended player retention, may favor that the game actually present and automatically count each happening of the desired event. In this fashion the player may not perceive the event as a relatively random occurrence but may actually see progress toward the jackpot event. Again, by using similar game occurrences, the events may be more simply perceived and remembered by the player. Naturally, of course, disparate game occurrences (such as one of each of a various list of items) may be utilized as well.

Regardless of the type of event(s) selected, it may be important for the jackpot event to be a non-consecutive, repetitive-occurrence jackpot event. By establishing such a type of jackpot event for the player, the player may be able to see constant progress or may at least perceive the event as more achievable and may continue to play the game so as to ultimately achieve the event. Thus the game may automatically count the multiple game event occurrence, compare the count, and even track prior game events, such as other occurrences of the same hand, or the like. By doing this for the player, the player may realize that the game tracks periodic events and may even include a periodic event determiner (18) as shown in FIG. 3. Again, it should be understood that the periodic event determiner (18) may be composed of individual elements previously discussed or may be its own separate element. By using repetitive events attained in different games or plays, the multiple event tracker (15) may even serve as a prior game event tracker. Since events may carry over from one game to another, the game may also provide for retaining the count or even automatically retaining the count across multiple game events.

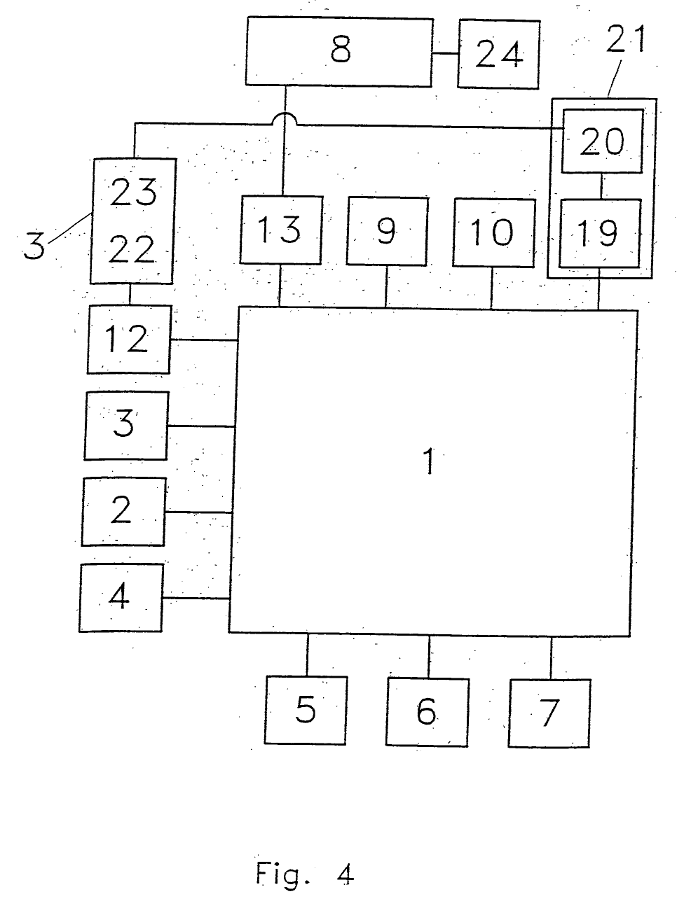

As mentioned earlier, the distance that the player is from the ultimate jackpot event may be a significant factor in retaining the player's participation in the game. It seems only intuitive that most typical players would not leave a game if they are only one not-improbable play away from an enhanced winning opportunity. In embodiments utilizing this concept, the system may be configured to include both distance calculation and distance display elements. Such a configuration is shown conceptually in FIG. 4. As can be seen, what was designated earlier as the event counter (11) may be replaced by or may include some type of jackpot distance calculation element (19). This jackpot distance calculation element (19) may influence or be responsive to a jackpot distance memory element (20). The jackpot distance memory element (20) may even serve to retain the actual jackpot distance from game to game. Together both jackpot distance memory element (20) and jackpot distance calculation element (19) may be components to an automatic jackpot distance alteration element (21). This element may in turn influence a player jackpot distance display (22).

As may be appreciated, the player jackpot distance display (22) may be separate or may be a portion of the display (3) presented to the player. This portion may even serve or incorporate or serve as part of an automatic jackpot distance decrementor (23). Through this type of a configuration it can be understood that the player can be more appropriately enticed to continue play of the game. By serving as a decrementor, that is a counting element which, decreases the number of events remaining, the player can actually see progress toward the ultimate jackpot event. For example, if the player is only three events away from a 60 event occurrence based on a not overly improbable occurrence, it seems unlikely that the player would quit playing the game. Instead, it seems likely the player would extend his or her play to continue so as to ultimately achieve those three events and obtain the known jackpot payout amount. Thus, in one embodiment, a game system could serve to alter the distance remaining or just alter any distance until the jackpot event is achieved.

By decreasing the distance rather than increasing the amount achieved, the game may serve to show constant progress to the player. This progress can be the result of events which occur throughout the player's interaction with the game. As another aspect of enticing the player, the display such as the player jackpot distance display (22) may be substantially continuously presented to the player. By being presented substantially continuously, the display may be shown to the player so that the player can constantly be reminded of progress toward an ultimate goal and constantly be reminded that they have achieved a certain amount of progress so far. This of course may be presented numerically or graphically. In this fashion, the entire system can include a jackpot distance decrementor which presents a decremented distance throughout the game. By indicating this distance, either periodically or substantially continuously, the player can constantly be reminded of an assured payout event if they simply continue the game for a long enough period of time.

As mentioned earlier, an important object of the invention is to expand the player's tolerance for continued play of a game. Certainly one can estimate the tolerance for a player's continued play of a game. This tolerance, may constitute a continued play tolerance. It may be input directly or indirectly by the system including a continued play player tolerance estimation element (24). As shown in FIG. 4, this continued play player tolerance estimation element may be part of or provide an input to the jackpot event standards element (8). In one embodiment, the continued play player tolerance estimation element (24) may provide for a number of optimal repetitive events as the determinant utilized (perhaps subconsciously) by the player to decide to continue to play the game. This number of events may vary as shown in Table 4. Again, naturally these should be viewed as representative only; in keeping with the broad coverage intended, other possibilities may be developed or may exist.

TABLE 4
OPTIMAL PLAY REPETITIVE EVENT NUMBERS
less than about 5 additional repetitive events
less than about 10 additional repetitive events
less than about 15 additional repetitive events
less than about 20 additional repetitive events
less than about 50 additional repetitive events
less than about 100 additional repetitive events
less than about 10 additional repetitive events for each machine
less than about 15 additional repetitive events for each machine
less than about 20 additional repetitive events for each machine
less than about 50 additional repetitive events for each machine
less than about 100 additional repetitive events for each machine
less than a number of repetitive events which represents minimum bets of less than about $1.00
less than a number of repetitive events which represents minimum bets of less than about $5.00
less than a number of repetitive events which represents minimum bets of less than about $10.00
less than a number of repetitive events which represents minimum bets of less than about $15.00
less than a number of repetitive events which represents minimum bets of less than about $20.00
less than a number of repetitive events which represents minimum bets of less than about $25.00
less than a number of repetitive events which represents minimum bets of less than about $50.00
less than a number of repetitive events which represents minimum bets of less than about $100.00
less than a number of repetitive events which represents minimum bets of less than about $500.00
less than a number of repetitive events which represents minimum bets of less than about
$1000.00

### Optimal Play Repetitive Event Numbers for One Type of System

In a situation where multiple machines are configured to be linked together, the continued play player tolerance estimation element (24) may even include events for each machine in the entire linkage of machines. As may be appreciated, in such an arrangement, the Jackpot standards element (8) may even be configured to serve as a composite jackpot event standards element. As can be seen from Table 4, the tolerances used may be represented by numbers of additional plays, minimum bets on plays, or even by a number of optimal repetitive events, such as only having four more full houses necessary in order to win the jackpot. While of course optimally (e.g., if ones luck were perfect) this may be achieved in four hands, it may statistically require more hands than that to ultimately be achieved.

As mentioned earlier, the game system may include some type of display (3). This display (3) may include a jackpot status display (25). The jackpot status display (25) may include or actually be a player jackpot distance display (22). Other aspects may also be included or provided. Of course, the jackpot status display (25) may be a substantially continuous player display. In situations where multiple jackpots are concurrently tracked, it may also represent a concurrent player jackpot status display. By indicating the jackpot status throughout the player's participation, the player may be able to monitor and constantly see progress as mentioned earlier. Attention may even be periodically drawn to the display through so activity programmed into the system. To the extent simplicity of presentation is deemed appropriate or optimal, the display may be substantially continuously displaying only one jackpot (for instance such as the one closest to being achieved) or it may indicate or display a plurality of multiple jackpots. Of course, it may also display every jackpot currently being tracked to the extent it is deemed not to overwhelm the player with information. As a component of retaining the player, it may be important to keep the game, the jackpot event, and even the presentation simple. System use of existing known poker hands, known games, and the like may be important in this regard.

As mentioned earlier, it may be significant to provide for common occurrences as a basis for jackpot calculation. It may even be appropriate to count losing hands or the like. For instance, while certain hands may be deemed to be a winning circumstance with winning defined as achieving some type of payout other than as part of a repetitive occurrence, other hands which normally achieve no or perhaps a smaller payout may be used for a jackpot as well. These may be referred to as losing circumstances. In such a situation, the jackpot standards that were met may actually comprise a losing circumstance jackpot standards element. Thus, by not only establishing but making available at least one losing circumstance based jackpot event to the player, the player may never feel that their luck is down as even the losing circumstances can present progress toward an ultimate payout. In this instance, a multiple event counter such as counter (11) may actually serve as a losing circumstance multiple event counter. Similarly, the comparator (16) and the multiple event tracker (15) may serve to actually track losing circumstances for jackpot purposes. Thus, the Jackpot standards element (8) may even be configured to serve as a no-win circumstance jackpot standards element.

One aspect that may be unique in some embodiments of this invention is the possibility of the system presenting a jackpot probability alteration element. For example, the periodic event determiner (18) or various elements relevant to it may actually serve as a jackpot probability alteration element in the sense that the probability of actually achieving a jackpot varies as the player progresses toward the jackpot event. For example, while it may be somewhat improbable for the player to achieve 60 events, when they only have three of those 60 events left, the actual jackpot probability may be dramatically varied. This could be especially significant if the machine is capable of being left in this almost finished state for another player. The varied probability may even exist in either a pure statistical sense or it may even exist only in a player's perception. Importantly, actions taken by the player can alter the probability of the jackpot ultimately occurring at any given point in time or within so many gaming events.

As mentioned, the payout element (4) may serve as a jackpot payout element. This may be activated and may pay the player achieving the ultimate number of events. While in one embodiment, the jackpot may be intrinsically associated with the game, in other embodiments it may not. For example, in order to be eligible for the jackpot, players may need to take certain actions. This can exist as a standard set at the beginning of the game or it may vary dynamically throughout the game. For example, as shown in Table 5, a variety of player criteria can be used to determine participation in the jackpot. (It may be noted that a distinction may even be made between the selection of a player for jackpot participation and the selection of the amount of the player's payout. Different elements to achieve these two distinct items may be included.) Notice that set amounts of play in a set time or play at a rate are both potential player criteria for an embodiment of the system. As to the player criteria for jackpot participation, again it should be understood that the criteria listed should be viewed as representative only; in keeping with the broad coverage intended, other possibilities may be developed or may exist.

TABLE 5
JACKPOT PARTICIPATION PLAYER CRITERIA
players having made a maximum bet
players having made a maximum bet during some time period
players having played a certain number of games
players having played a certain number of games during some time period
players having played 25 games
players having played 50 games
players having played 100 games
players having played 250 games
players having played 500 games
players having played 1000 games
players having played or played at a rate of 12 games during a 1 minute time period
players having played or played at a rate of 75 games during a 10 minute time period
players having played or played at a rate of 90 games during a 10 minute time period
players having played or played at a rate of 80 games during a 20 minute time period
players having played 12 games during a 1 minute time period
players having played 75 games during a 10 minute time period
players having played 90 games during a 10 minute time period
players having played 80 games during a 20 minute time period
players having played at a rate of 12 games during a 1 minute time period
players having played at a rate of 75 games during a 10 minute time period
players having played at a rate of 90 games during a 10 minute time period
players having played at a rate of 80 games during a 20 minute time period
players having played a certain dollar amount during some time period
players having played a variable dollar amount in a unit period of time
players having played an increasing dollar amount in a unit period of time as the jackpot event
gets closer
players having played a $25.00 amount
players having played a $50.00 amount
players having played a $100.00 amount
players having played a $250.00 amount
players having played a $500.00 amount
players having played or played at a rate of a $50.00 amount during a 1 hour time period
players having played or played at a rate of a $100.00 amount during a 1 hour time period
players having played or played at a rate of a $250.00 amount during a 2 hour time period
players having played or played at a rate of a $500.00 amount during a 5 hour time period
players having played $50.00 amount during a 1 hour time period
players having played $100.00 amount during a 1 hour time period
players having played $250.00 amount during a 2 hour time period
players having played $500.00 amount during a 5 hour time period

### Jackpot Participation Player Criteria

As can be seen from Table 5, participation may require play within a certain amount of time. By periodically requiring specified events, the players may realize they have to achieve certain things in order to be counted in the payoff. As mentioned earlier, since the events may be time based, the system may include a timer (27). This may also include a time limit memory element (28). This time limit memory element (28) may even represent timing between actions in a game. In this fashion, a frenzy can be developed whereby the player must play a number of events within a varying amount of time. They may even be required to compete with each other to gain an increased share of the jackpot payout. By varying the amount of time, the system may actually be able to develop a frenzy among players where those participating must be rapidly playing the game in order to be counted for potentially even a varying percentage of the jackpot payout. This could be significant in situations in which a relatively large jackpot payout is certain and is only a number of plays away. By rushing the player to continually play more and more games in a given period of time for higher participation or any participation at all, the players can become frenzied over the participation. This not only can achieve greater player satisfaction and entertainment, but it also may help retain the player for a longer period of time or enhance operator profits. These events may also be required in order to avoid a resetting of the jackpot counter or resetting of the jackpot event. Similarly, the variability of a required event may not just be time based, but may require events such as a minimum bet or a maximum bet or the like. In this fashion the jackpot association element (13) may include a minimum-bet-or-better jackpot association element or other such aspect. There may even be included a maximum bet determiner (29) such as to determine if the player has made the maximum bet in order to be included or otherwise. A simple player confirmation element (30) may also be included to make sure that the player has not stopped playing the machine. Finally, continued participation or some degree of participation may be determined through the use of some sort of random event generator (31) so as to require an unknown action in order to be considered a participant in the jackpot. Perhaps most significantly, though, by keeping, a jackpot available to the player even if requiring an increasing dollar amount in a unit period of time such as the frenzied play embodiment described earlier, the player may be retained even as the jackpot event gets closer.

Of course variations in the payouts may be selected as appropriate. For instance, the player achieving the final step may be paid, or the player achieving the final step may achieve a significant portion of the jackpot amount. Al this can be varied significantly as the jackpot gets closer to even achieve a somewhat more frenzied play among those participating. For instance the players playing above a particular rate may even achieve a higher amount of winnings.

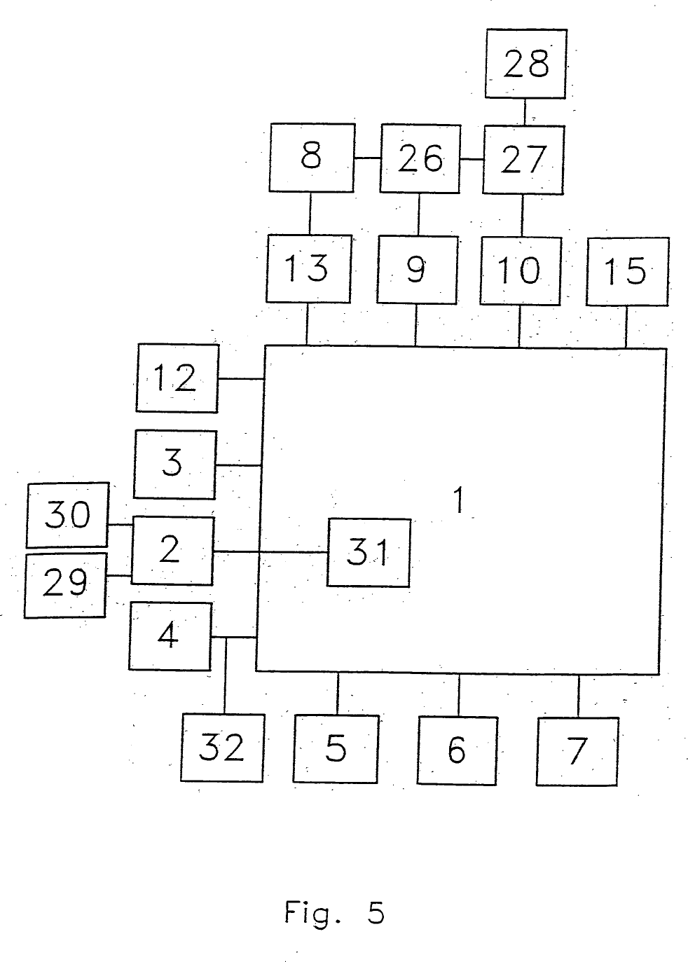

Once a jackpot is paid it may be appropriate to reset the counter or reset the event. It may even reset to a pre-determined base level. By presenting the jackpot event across a variety of game plays, the payout element (4) may actually be an intergame jackpot payout element to which the jackpot reset (9) may be responsive. Jackpot reset may also occur by other than payout. For example, it may be time based and may even include some type of alarm to warn the player of an imminent occurrence of reset. This may also provide the player an opportunity to take action to avoid the reset event. Such a system is shown in FIG. 5 in which the basic system is expanded to include the jackpot reset alarm (26) and potentially even a timer (27). These, of course, may be configured in any fashion and again since software may be involved, the elements may not may not even connected as indicated for merely conceptual purposes. As mentioned, the system may acquire certain events of a player in order to be considered as part of the jackpot event. For instance, playing the game within a specified amount of time may be required either individually or in a linked machine embodiment. Similarly, occasional or isolated maximum betting may be required. It may even be as simple as the player indicating that they are still playing the game in order to be counted for the jackpot or in order for the jackpot counter not to be reset. To the extent these elements are included, the display (3) may include or may actually be a player jackpot reset-avoidance information display. In such a fashion the display may tell the player the actions necessary in order to avoid being dropped from jackpot participation or in order to avoid reset of the jackpot counting.

Perhaps a fundamental concept presented in this invention is the aspect of providing for a jackpot which can be configured as one which is never lost. This jackpot may be retained among various game events as an intergame event without being affected by other plays, other players, or other occurrences. Being unaffected by other's play may also contribute to the sense of being unaffected by other's bad luck. Regardless, of the effect on the player's perceptions, the jackpot standards element (8) may also include or be a jackpot probability retainer, or any type of retainer which keeps the jackpot going between gaming events. In aspects presenting the possibility of an altered probability of occurrence, this altered probability may be retained as well.

In keeping with the concept of having a jackpot which is never lost, the system may include a time unrestricted element in place of the timer (27). The time unrestricted element may even be provided through an absence of a contrary element. The time unrestricted element may provide no time limit on actions by the player in order to avoid any reset of the jackpot counting. Thus, the jackpot carryover (10) may continue unaffected by the actions of others so long as the player continues to interact with the game or even so long as the game is on. By carrying at least one of the jackpot events across to another game, the player may be enticed to continue playing the game as is an important object of the inventions. Representing a jackpot across individual game events in continued play, the payout element (4) may actually present an intergame jackpot payout element and even the jackpot event may be an intergame jackpot event.

A potentially important component for players being retained and continuing to play is the possibility of presentation of concurrent jackpot events. For instance, a system may concurrently present a plurality of jackpot events to the player. The jackpot events may be offered or presented in a fashion such that the player is always close to one or another of the events. In this manner, a staggered probability jackpot event may be desired. By presenting multiple staggered probability jackpot events, it is possible to configure the game so that the player is at any point in time close to one or another event. Since each of these may be automatically counted for each different game event, and since each may be concurrently displayed in some embodiments, the system may provide a plurality of multiple event trackers, a plurality of distance calculation elements, a plurality of distance decrementors, and the like. Each of these may be important to constantly retaining the player's attention and participation in the game. For example, at any one given point in time, the player may be only three or four or so events away from obtaining the jackpot payout. In this fashion it may be unlikely or at least may be more difficult for the player to leave the game. Importantly, the player may take an attitude that they would prefer not to quit the game and would prefer to continue to play just a little bit longer in order to achieve the very next jackpot event.

As mentioned earlier, all of this may be done with linked machines as well as singular machines. In this fashion players may see progress even when they themselves do not achieve it. By combining players on different machines, each action by each player may be utilized to present a composite jackpot event for each player in the system. All players playing in the system in any given point in time, all players having achieved or accomplished certain events, all players having made certain plays or the like may be participating as determined to be optimal for extended player retention.

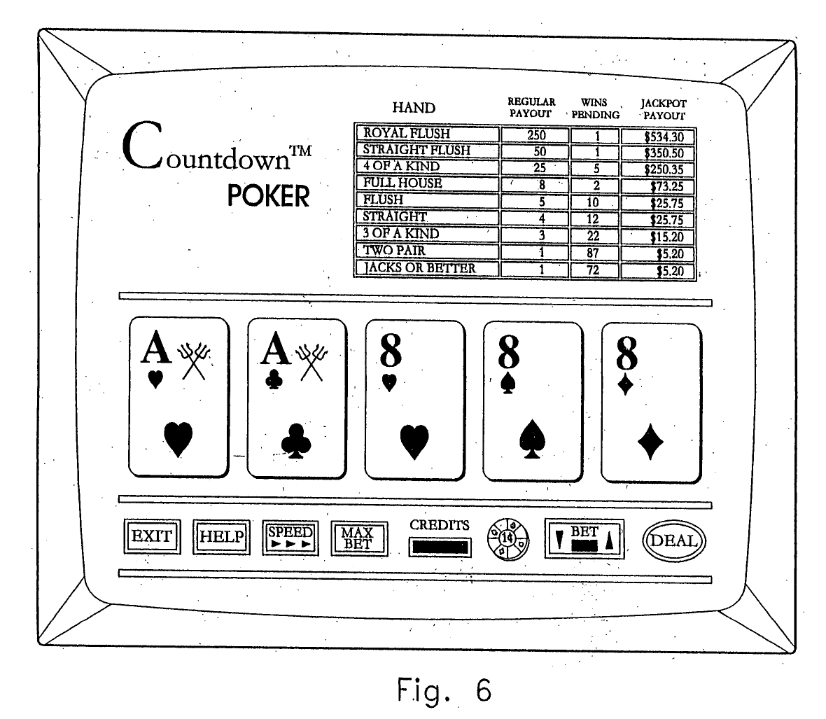

Furthermore, the jackpot event may be selected from a host of different events which may be listed as above. Various poker games possibly used in this system may be varied as well. A sample of some of the poker games which may be employed is listed in Table 6. As but one embodiment of the gaming system, a poker implementation can even be designed as a special progressive poker game where a percentage of the bet goes into a kitty every time a certain hand is hit. When a predetermined number of hands are hit of that type of hand, the player gets the total of the jackpot. An exemplary paytable using a one bet design is shown in Table 7. When the counter reaches 0, the player may receive what is in the jackpot at that point in time. The amount that is put into that jackpot can also vary depending on the amount bet and the value of that hand. There may even be bonuses that can only be won by the maximum bet player. Further, if certain hands are hit while betting the maximum, and the decremented distance hits zero, there may be added a specific amount to the jackpot payout. Values such as adding $300 on a royal flush diamonds, adding $200 on hitting a mini royal, adding $150 on hitting four aces, or even adding $100 when hitting a full house of aces and eights are all but one set of possibilities. Consistent with an embodiment in which each hit may cause a jackpot contribution, it can be seen in the expanded display shown in FIG. 6 how one game can progress to increase jackpots amounts. As to each of these table values, again, these should be viewed as representative only; in keeping with the broad coverage intended, other possibilities may be developed or may exist.

TABLE 6
POKER GAMES WHICH MAY BE
THE SUBJECT OF BY THE SYSTEM
Aces and Eights
All American Poker
Bonus Poker
Bonus Poker Delux
Double Bonus Poker
Double Double Bonus Poker
Double Double Jackpot Poker
Double Jackpot Poker
Jacks or Better
Bonus Deuces Wild
Deuces Wild
Deuces Delux
Deuces and Joker Wild
Double Joker Poker
Four Joker Poker
Five Joker Poker
Joker Wild - Kings or Better
Joker Wild - Aces or Better
Joker Wild - 2 Pair or Better
Joker Wild - AC 5K Jackpot
Loose Deuces
Sevens Wild
Pick'em Poker

### Sampling of Poker Games which May be Generated by the System

TABLE 7

| | Added to JP | Number of | | | Jackpot |
|---|---|---|---|---|---|
| | When Hit | hands for JP | Win | Jackpot (JP) | Starts |
| Royal Flush | 5000% | 2 | 800 | Progressive | $200.00 |
| Straight | 1000% | 5 | 60 | Progressive | $50.00 |
| Flush | | | | | |
| 4 of a Kind | 300% | 10 | 25 | Progressive | $20.00 |
| Full House | 100% | 20 | 8 | Progressive | $10.00 |
| Flush | 100% | 25 | 5 | Progressive | $10.00 |
| Straight | 100% | 25 | 4 | Progressive | $10.00 |
| 3 of a Kind | 50% | 100 | 3 | Progressive | $5.00 |
| Two Pair | | | 1 | | |
| Jacks or | | | 1 | | |
| Better | | | | | |

### Sample Poker Pay Table for One Type of Poker-Based System

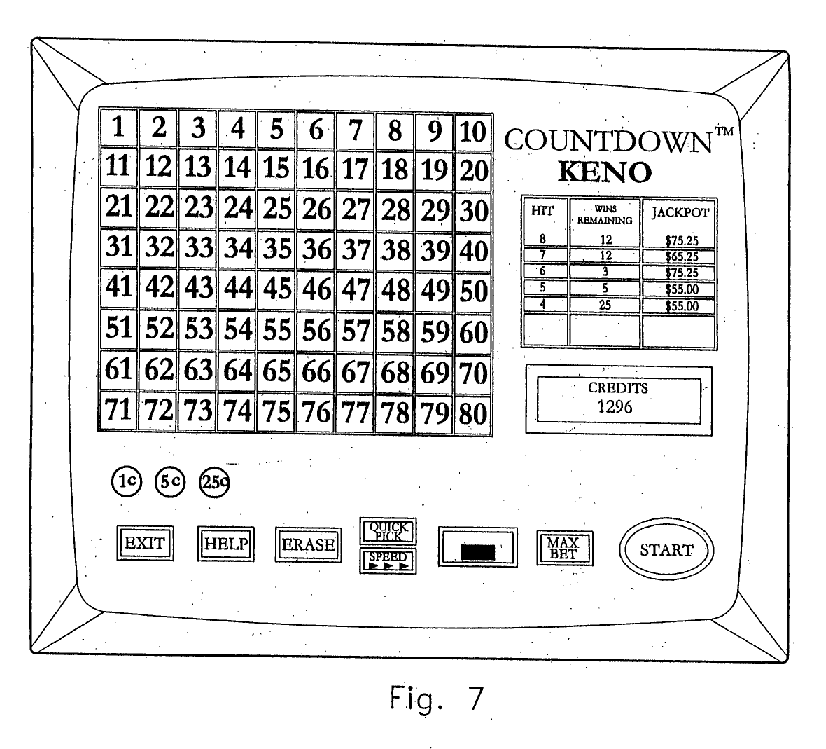

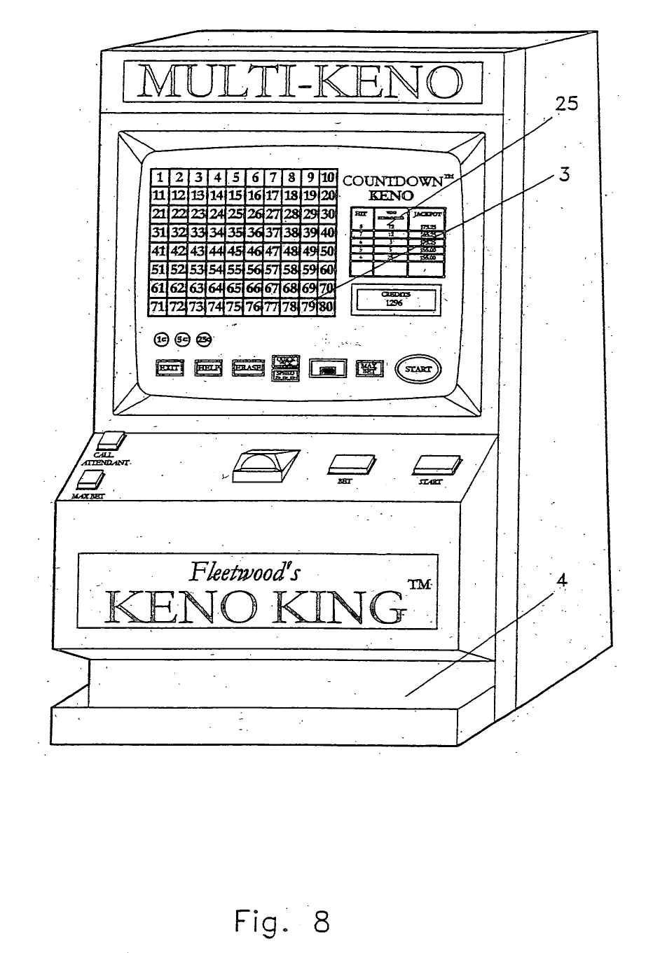

As should be appreciated, a variety of designs are possible for other games as well. Using Keno as an example, it can be seen how a basic system may be established to retain Keno players. FIG. 7 illustrates one type of Keno display according to one embodiment of the invention. FIG. 8 shows a representative device design for one type of Keno game. As can be seen, this design illustrates an electronic Keno game with a video display for the player. A sample pay table for one basic Keno design is shown in Table 8. Again, these values should be viewed as representative only; in keeping with the broad coverage intended, other possibilities may be developed or may exist for any game.

TABLE 8

| Marks- | Added to JP | Number of | | Jackpot Starts |
|---|---|---|---|---|
| # Out of # | When Hit | hands for JP | Jackpot (JP) | (credits) |
| 3-4 | 100% | 40 | Progressive | 80 |
| 4-5 | 100% | 30 | Progressive | 80 |
| 5-6 | 200% | 25 | Progressive | 100 |
| 6-7 | 200% | 20 | Progressive | 100 |
| 6-8 | 100% | 40 | Progressive | 80 |
| 7-9 | 100% | 35 | Progressive | 80 |
| 8-10 | 100% | 30 | Progressive | 80 |

### Sample Keno Pay Table for One Type of Keno-Based System

As mentioned earlier, and regardless of the type of game presented, the jackpot event may be based upon a relatively common occurrence. Specific hands may be used in card games as a basis for the jackpot. This itself may be unique in that it is not typically considered possible to use common occurrence events such as a full house or a pair or jacks or better game outcomes as a basis for a jackpot payout. Importantly, though, by using relatively common events the player may be retained for a longer period of time and the profits remaining after the payout of winnings and even jackpots may be a greater amount for the casino or game operator. In this fashion the game system may include a profit retainer (32) for the casino's continued involvement and profit. Thus beside providing enhanced player satisfaction, the invention may ultimately provide greater profits to the operator or casino as an important part of coverage.

As mentioned above, the discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in functionally-oriented terminology, each aspect of the function can be accomplished by a device, person, subroutine, or program. To varying degrees, apparatus claims are not only included for the devices described, but also method claims are included to address the functions the invention and each element performs. Neither the description nor the terminology is intended to limit the scope or degree of the claims which may be included as supported by this description.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical elements disclosed should be understood to encompass a disclosure of the action which that physical element facilitates. As but one example, the disclosure of a “timer” should be understood to encompass disclosure of the act of “timing”—whether explicitly discussed or not—and, conversely, were there only disclosure of the act of “timing”, such a disclosure should be understood to encompass disclosure of a “timer” and even a “means for timing”. Such changes and alternative terms are to be understood to be explicitly throughout the description and claims. Additionally, the various combinations and permutations of all elements, steps, and applications should be understood as within and supported by this disclosure. Any of these should be understood as capable of being presented at any time, whether initially claimed or not.

In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. However, as to these as well, to the extent that such information or statements incorporated by reference might be considered inconsistent with the patenting of this/these invention(s) such statements are expressly not to be considered as made by the applicant(s).

Throughout the desicrption, including the claims, it should be understood that the term “at least one” as used in this document and in the claims is not intended nor used to mean that other claims or descriptions not incorporating the “at least one” language cannot further include one or more like elements. The language “at least one” is not intended nor used to change “open-ended” claims, inherently including devices or methods having additional elements or steps apart from those claimed, into “closed-ended” claims wherein devices or methods having additional elements would not be covered by such claims. Further, when used, the use of the transitional phrase “comprising” is used to maintain the “open-end” claims, according to traditional claim interpretation. Thus, it should be understood that the term “comprise” or variations such as “comprises” or “comprising” or the like, are intended to imply the inclusion of a stated element or step or group of elements or steps but not the exclusion of any other element or step or group of elements or steps. Such terms should be interpreted in their most expansive form so as to afford the applicant the broadest coverage legally permissible. It may even be replaced with terms such as “including” or terms deemed to give the maximum legal protection as may be desirable in countries such as Australia and the like.

Any acts, rules, or the like applicable to the use of this technology, any patents, publications, or other references mentioned or listed are hereby incorporated by reference. Furthermore, the earlier priority application, U.S. Application No. 60/272,666 (with its incorporated references) and the following list of references are hereby incorporated by reference in their entirety. However, to the extent statements made therein might be considered inconsistent with the patenting of this invention such statements are expressly not to be considered as made by the applicant(s).

| DOCUMENT | | | | | FILING |
|---|---|---|---|---|---|
| NO. | DATE | NAME | CLASS | SUBCLASS | DATE |
| 4,861,041 | Aug. 29, 1989 | Jones, et al. | 273 | 292 | Jul. 5, 1988 |
| 5,280,909 | Jan. 25, 1994 | Tracy | 273 | 138 | Feb. 6, 1992 |
| 5,377,973 | Jan. 3, 1995 | Jones, et al. | 273 | 85 | Feb. 14, 1994 |
| 5,487,547 | Jan. 30, 1996 | Hobert | 273 | 274 | Sep. 13, 1994 |
| 5,531,448 | Jul. 2, 1996 | Moody | 495 | 952 | Jun. 28, 1995 |
| 5,536,016 | Jul. 16, 1996 | Thompson | 273 | 269 | Sep. 26, 1994 |
| 5,564,700 | Oct. 15, 1996 | Celona | 463 | 27 | Feb. 10, 1995 |
| 5,586,766 | Dec. 24, 1996 | Forte, et al. | 439 | 687 | May 12, 1995 |
| 5,725,216 | Mar. 10, 1998 | Jones | 273 | 292 | Oct. 13, 1995 |
| 5,803,809 | Sep. 8, 1998 | Yoseloff | 463 | 13 | Sep. 18, 1996 |
| 5,851,147 | Dec. 22, 1998 | Stupak, et al. | 717 | 383 | Sep. 17, 1996 |
| 5,934,998 | Aug. 10, 1999 | Forte, et al. | 463 | 12 | Nov. 14, 1996 |
| 5,951,011 | Sep. 14, 1999 | Potter, et al. | 273 | 292 | Jul. 18, 1997 |
| 6,015,347 | Jan. 18, 2000 | Maahs, et al. | 463 | 27 | Dec. 26, 1996 |
| 6,024,642 | Feb. 15, 2000 | Stupak | 463 | 20 | Dec. 16, 1997 |
| 6,045,130 | Apr. 4, 2000 | Jones, et al. | 273 | 292 | Mar. 9, 1999 |
| 6,059,659 | May 9, 2000 | Busch, et al. | 463 | 17 | Jun 6, 1997 |
| 6,068,553 | May 30, 2000 | Parker | 463 | 27 | Sep. 15, 1997 |
| 6,073,930 | Jun. 13, 2000 | Jones, et al. | 273 | 292 | Nov. 12, 1997 |
| 6,109,612 | Aug. 29, 2000 | Moore | 273 | 292 | Jul. 26, 1999 |
| 6,110,043 | Aug. 29, 2000 | Olsen | 463 | 27 | Oct. 24, 1997 |
| 6,179,290 B1 | Jan. 30, 2001 | Maahs | 273 | 292 | Dec. 26, 1996 |

Finally, the claims initially set forth with this application are all hereby incorporated by reference as part of this description of the invention. The applicant expressly reserves the right to use all of or a portion of such incorporated content as additional description to support, present, or re-present any of or all of the claims or any element or component thereof, and the applicant further expressly reserves the right to move any portion of or all of the incorporated content or any element or component thereof from the description into the claims and vice-versa as necessary to define the matter for which protection is sought by this application or by any subsequent continuation, division, or continuation-in-part application thereof, or to obtain any benefit of any reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon regardless of any claims amendments or the like presented.

1. A method of gaming to achieve extended player retention comprising the steps of:
a. providing a particular game process to a player;
b. involving said player in some aspect of said game process;
c. establishing at least one non-consecutive, repetitive- and common-occurrence jackpot event based upon at least one relatively common event in said game process;
d. intrinsically associating said at least one non-consecutive, repetitive- and common-occurrence jackpot event with said game process;
e. intrinsically presenting said at least one non-consecutive, repetitive- and common-occurrence jackpot event to said player as part of said game process;
f. making said at least one non-consecutive, repetitive- and common-occurrence jackpot event available to said player as part of an interaction with said game process;
g. indicating a distance said player is from said at least one jackpot event to said player;
h. decrementing said distance said player is from said at least one jackpot event as a result of events which occur in said game process to create a decremented distance said player is from said at least one jackpot event;
i. indicating said decremented distance said player is from said at least one jackpot event to said player; and
j. paying said player a jackpot amount upon said player attaining said non-consecutive, repetitive- and common-occurrence jackpot event in said game process.

2. A method of gaming to achieve extended player retention as described in claim 1 and further comprising the steps of:
a. tracking each happening of a multiple event occurrence in said game process for said player,
b. retaining said at least one jackpot event for said player without said at least one jackpot event being affected by actions of others for at least so long as said player continues to interact with said game process.

3. A method of gaming to achieve extended player retention as described in claim 2 wherein said step of retaining said at least one jackpot event for said player without said at least one jackpot event being affected by actions of others for at least so long as said player continues to interact with said game process further comprises the steps of:
a. warning said player of an imminent reset of said at least one jackpot event; and
b. providing said player an opportunity to to take an action to avoid the occurrence of said reset.

4. A method of gaming to achieve extended player retention as described in claim 3 wherein said step of providing said player an opportunity to to take an action to avoid the occurrence of said reset comprises a step selected from a group consisting of: requiring specified events in said game process from said player, playing said game process within a specified time, making a maximum bet in said game process, taking any action indicating that game is still being played, and taking a randomly generated action in said game process.

5. A method of gaming to achieve extended player retention as described in claim 1 wherein said step of establishing at least one jackpot event comprises the step of establishing at least one jackpot event selected from a group of game events consisting of:
game events having a probability of greater than about 100 in 10,000,
game events having a probability of greater than about 110 in 10,000,
game events having a probability of greater than about 130 in 10,000,
game events having a probability of greater than about 220 in 10,000,
game events having a probability of greater than about 550 in 10,000,
game events having a probability of greater than about 700 in 10,000,
game events having a probability of greater than about 1200 in 10,000,
game events having a probability of greater than about 2000 in 10,000, and
game events having a probability of greater than about 5000 in 10,000.

6. A method of gaming to achieve extended player retention as described in claim 1 wherein said step of establishing at least one jackpot event comprises the step of establishing at least one jackpot event based upon a game event in said game process selected from a group of game events consisting of: a straight game event, a flush game event, a full house game event, a three-of-a-kind game event, a two pair game event, a jacks-or-better game event, a queens-or-better game event, a kings-or-better game event, an aces-or-better game event, and a losing game event.

7. A method of gaming to, achieve extended player retention as described in claim 1 wherein said step of establishing at least one jackpot event comprises the step of establishing a jackpot event selected from a group consisting of:
a jackpot event requiring at least about 2 non-consecutive game event occurrences,
a jackpot event requiring at least about 5 non-consecutive game event occurrences,
a jackpot event requiring at least about 5 game event occurrences,
a jackpot event requiring at least about 10 game event occurrences,
a jackpot event requiring at least about 20 game event occurrences,
a jackpot event requiring at least about 40 game event occurrences,
a jackpot event requiring at least about.50 game event occurrences,
a jackpot event requiring at least about 60 game event occurrences,
a jackpot event requiring at least about 80 game event occurrences, and
a jackpot event requiring at least about 100 game event occurrences.

8. A method of gaming to achieve extended player retention as described in claim 1 wherein said step of providing a game process to a player comprises the steps of:
a. instituting an individual game for said player;
b. concluding said individual game for said player; and
c. reinstituting another individual game for said player as part of said game process,
and wherein said step of establishing at least one jackpot event comprises the step of carrying said at least one jackpot event across said step of concluding said individual game for said player and said step of reinstituting another individual game for said player as part of said game process.

9. A method of gaming to achieve extended player retention as described in claim 1 wherein said step of establishing at least one non-consecutive, repetitive- and common-occurrence jackpot event based upon at least one relatively common event in said game process comprises the step of establishing a plurality of non-consecutive, repetitive- and common-occurrence jackpot events based upon at least one relatively common event in said game process, wherein said step of intrinsically associating said at least one non-consecutive, repetitive- and common-occurrence jackpot event with said game process comprises the step of intrinsically associating said plurality of non-consecutive, repetitive- and common-occurrence jackpot events with said game process, wherein said step of making said at least one non-consecutive, repetitive- and common-occurrence jackpot event available to said player as part of an interaction with said game process comprises the step of making said plurality of non-consecutive, repetitive- and common-occurrence jackpot events available to said player as part of an interaction with said game process, and wherein said step of paying said player a jackpot amount upon said player attaining said non-consecutive, repetitive- and common-occurrence jackpot event in said game process comprises the step of paying said player a jackpot amount upon said player attaining at least one of said plurality of non-consecutive, repetitive- and common-occurrence jackpot events in said game process, and further comprising the step of concurrently presenting said plurality of non-consecutive, repetitive- and common-occurrence jackpot events to said player as part of said game process.

10. A method of gaming to achieve extended player retention as described in claim 9 wherein said step of establishing a plurality of non-consecutive, repetitive- and common-occurrence jackpot events in said game process comprises the step of selecting a plurality of staggered probability jackpot events for said game process.

11. A method of gaming to achieve extended player retention as described in claim 10 wherein said step of selecting a plurality of staggered probability jackpot events for said game process comprises the step of establishing a plurality of staggered probability jackpot events for said game process such that at least one of said staggered probability jackpot events is typically within a continued play tolerance for a typical player.

12. A method of gaming to achieve extended player retention as described in claim 11 wherein said step of establishing a plurality of staggered probability jackpot events for said game process such that at least one of said staggered probability jackpot events is typically within a continued play tolerance for a typical player comprises the step of utilizing staggered probability jackpot events such that at least one is typically within a number of optimal repetitive events selected from a group consisting of:
less than about 5 additional repetitive events,
less than about 10 additional repetitive events,
less than about 15 additional repetitive events,
less than about 20 additional repetitive events,
less than about 50 additional repetitive events,
less than about 100 additional repetitive events,
less than about 10 additional repetitive events for each machine participating in said jackpot event,
less than about 15 additional repetitive events for each machine participating in said jackpot event,
less than about 20 additional repetitive events for each machine participating in said jackpot event,
less than about 50 additional repetitive events for each machine participating in said jackpot event,
less than about 100 additional repetitive events for each machine participating in said jackpot event,
less than a number of repetitive events which represents minimum bets of less than about $1.00,
less than a number of repetitive events which represents minimum bets of less than about $5.00,
less than a number of repetitive events which represents minimum bets of less than about $10.00,
less than a number of repetitive events which represents minimum bets of less than about $15.00,
less than a number of repetitive events which represents minimum bets of less than about $20.00,
less than a number of repetitive events which represents minimum bets of less than about $25.00,
less than a number of repetitive events which represents minimum bets of less than about $50.00,
less than a number of repetitive events which represents minimum bets of less than about $100.00,
less than a number of repetitive events which represents minimum bets of less than about $500.00, and
less than a number of repetitive events which represents minimum bets of less than about $1000.00.

13. A method of gaming to achieve extended player retention as described in claim 1 wherein said step of establishing at least jackpot event comprises the step of establishing at least one losing circumstance based jackpot event in said game process.

14. A method of gaming to achieve extended player retention as described in claim 1 wherein said step of paying said player said jackpot amount comprises the step of determining if said player has achieved a selected event from a group consisting of:
having made a maximum bet,
having made a maximum bet during some time period,
having played a certain number of games,
having played a certain number of games during some time period,
having played 25 games,
having played 50 games,
having played 100 games,
having played 250 games,
having played 500 games,
having played 1000 games,
having played or played at a rate of 12 games during a 1 minute time period,
having played or played at a rate of 75 games during a 10 minute time period,
having played or played at a rate of 90 games during a 10 minute time period,
having played or played at a rate of 80 games during a 20 minute time period,
having played a certain dollar amount during some time period,
having played a variable dollar amount in a unit period of time,
having played an increasing dollar amount in a unit period of time as said jackpot event gets closer,
having played a $25.00 amount,
having played a $50.00 amount,
having played a $100.00 amount,
having played a $250.00 amount,
having played a $500.00 amount,
having played or played at a rate of a $50.00 amount during a 1 hour time period,
having played or played at a rate of a $100.00 amount during a 1 hour time period,
having played or played at a rate of a $250.00 amount during a 2 hour time period, and
having played or played at a rate of a $500.00 amount during a 5 hour time period.

15. A game device to achieve extended player retention comprising:
a. a game generator capable of providing a particular game process to a player;
b. a player interaction element through which said player can participate in said game process;
c. a non-consecutive, repetitive- and common-occurrence jackpot standards element responsive to said game process and based upon at least one relatively common event in said game process;
d. an intrinsic jackpot association element responsive to said common-occurrence jackpot standards element and to events within said game process;
e. a multiple event tracker responsive to events within said game process;
f. a jackpot distance calculation element responsive to said jackpot standards element and said game process;
g. a jackpot distance memory element responsive to said jackpot distance calculation element;
h. a player jackpot distance display responsive to said jackpot distance memory element;
i. a jackpot distance decrementer responsive to said game process and to which said jackpot distance memory element is responsive; and
j. a jackpot payout element responsive to said jackpot distance calculation element.

16. A game device to achieve extended player retention as described in claim 15 wherein said non-consecutive, repetitive- and common-occurrence jackpot standards element responsive to said game process and based upon at least one relatively common event in said game process comprises an intergame jackpot standards element responsive to said game process, and further comprising:
a. a multiple event tracker responsive to events within said game process;
b. a comparator responsive to said intergame jackpot standards element and said multiple event tracker, and wherein said jackpot payout element responsive to said jackpot distance calculation element comprises an intergame jackpot payout element responsive to said comparator.

17. A game device to achieve extended player retention as described in claim 16 and further comprising:
a. a jackpot reset alarm; and
b. a player jackpot reset-avoidance information display.

18. A game device to achieve extended player retention as described in claim 17 and further comprising a periodic event determiner selected from a group consisting of:
a game process event timer, a maximum bet determiner, a player confirmation element, and a random event generator.

19. A game device to achieve extended player retention as described in claim 15 wherein said jackpot standards element comprises a jackpot standards element utilizing game events in said game process selected from a group of game events consisting of:
game events having a probability of greater than about 100 in 1000,
game events having a probability of greater than about 100 in 10,000,
game events having a probability of greater than about 130 in 10,000,
game events having a probability of greater than about 220 in 10,000,
game events having a probability of greater than about 550 in 10,000,
game events having a probability of greater than about 700 in 10,000,
game events having a probability of greater than about 1200 in 10,000,
game events having a probability of greater than about 2000 in 10,000, and
game events having a probability of greater than about 5000 in 10,000.

20. A game device to achieve extended player retention as described in claim 15 wherein said jackpot standards element comprises a jack pot standards element utilizing game events in said game process selected from a group of game events consisting of a straight game event, a flush game event, a full house game event, a three-of-a-kind game event, a two pair game event, a jacks-or-better game event, a queens-or-better game event, a kings-or-better game event, an aces-or-better game event, and a losing game event.

21. A game device to achieve extended player retention as described in claim 15 wherein said jackpot standards event element comprises a high event occurrence number jackpot event element selected from a group consisting of:
a jackpot event element requiring at least about 2 non-consecutive game event occurrences,
a jackpot event element requiring at least about 5 non-consecutive game event occurrences,
a jackpot event element requiring at least about 5 game event occurrences,
a jackpot event element requiring at least about 10 game event occurrences,
a jackpot event element requiring at least about 20 game event occurrences,
a jackpot event element requiring at least about 40 game event occurrences,
a jackpot event element requiring at least about 50 game event occurrences,
a jackpot event element requiring at least about 60 game event occurrences,
a jackpot event element requiring at least about 80 game event occurrences, and
a jackpot event element requiring at least about 100 game event occurrences.

22. A game device to achieve extended player retention as described in claim 15 wherein said game generator capable of providing a particular game process to a player comprises:
a. a game initiator;
b. a game conclusion element; and
c. a game reinitiator,
and wherein said jackpot standards element comprises a jackpot carryover which is unaffected by operation of either said game conclusion element or said game reinitiator.

23. A game device to achieve extended player retention as described in claim 15 wherein said non-consecutive, repetitive- and common-occurrence jackpot standards element responsive to said game process and based upon at least one relatively common event in said game process comprises a a plurality of concurrent repetitive-occurrence jackpot standards elements responsive to said game process, wherein said player jackpot distance display responsive to said jackpot distance memory element comprises at least one concurrent player jackpot status display responsive to said plurality of concurrent repetitive-occurrence jackpot standards elements, and wherein said jackpot payout element responsive to said jackpot distance calculation element comprises a jackpot payout element responsive to said plurality of concurrent repetitive-occurrence jackpot standards elements.

24. A game device to achieve extended player retention as described in claim 15 wherein said jackpot standards element comprises a staggered probability repetitive-occurrence jackpot event element.

25. A game device to achieve extended player retention as described in claim 24 wherein said staggered probability repetitive-occurrence jackpot event element comprises a continued play player tolerance estimation element.

26. A game device to achieve extended player retention as described in claim 25 wherein said continued play player tolerance estimation element comprises a continued play player tolerance estimation element utilizing jackpot events such that at least one is typically within a number of optimal repetitive events selected from a group consisting of:
less than about 10 additional repetitive events,
less than about 15 additional repetitive events,
less than about 20 additional repetitive events,
less than about 50 additional repetitive events,
less than about 100 additional repetitive events,
less than about 10 additional repetitive events for each machine participating in said jackpot event,
less than about 15 additional repetitive events for each machine participating in said jackpot event,
less than about 20 additional repetitive events for each machine participating in said jackpot event,
less than about 50 additional repetitive events for each machine participating in said jackpot event,
less than about 100 additional repetitive events for each machine participating in said jackpot event,
less than a number of repetitive events which represents minimum bets of less than about $5.00,
less than a number of repetitive events which represents minimum bets of less than about $10.00,
less than a number of repetitive events which represents minimum bets of less than about $15.00,
less than a number of repetitive events which represents minimum bets of less than about $20.00,
less than a number of repetitive events which represents minimum bets of less than about $25.00,
less than a number of repetitive events which represents minimum bets of less than about $50.00, and
less than a number of repetitive events which represents minimum bets of less than about $100.00.

27. A game device to achieve extended player retention as described in claim 15 wherein said jackpot standards element comprises at least one losing circumstance jackpot standards element responsive to said game process.

28. A game device to achieve extended player retention as described in claim 15 wherein said payout element comprises a payout element which determines if a player has achieved an event selected from a group consisting of:
having made a maximum bet,
having made a maximum bet during some time period,
having played a certain number of games,
having played a certain number of games during some time period,
having played 25 games,
having played 50 games,
having played 100 games,
having played 250 games,
having played 500 games,
having played 100 games,
having played 1000 games,
having played or played at a rate of 12 games during a 1 minute time period,
having played or played at a rate of 75 games during a 10 minute time period,
having played or played at a rate of 90 games during a 10 minute time period,
having played or played at a rate of 80 games during a 20 minute time period,
having played a certain dollar amount during some time period,
having played a variable dollar amount in a unit period of time,
having played an increasing dollar amount in a unit period of time as said jackpot event gets closer,
having played a $25.00 amount,
having played a $50.00 amount,
having played a $100.00 amount,
having played a $250.00 amount,
having played a $500.00 amount,
having played or played at a rate of a $50.00 amount during a 1 hour time period,
having played or played at a rate of a $100.00 amount during a 1 hour time period,
having played or played at a rate of a $250.00 amount during a 2 hour time period, and
having played or played at a rate of a $500.00 amount during a 5 hour time period.

29. A method of gaming to achieve extended player retention comprising the steps of:
a. providing a particular game process to a player;
b. involving said player in some aspect of said game process;
c. establishing at least one intergame jackpot event in said game process;
d. associating said at least one intergame jackpot event with a multiple event occurrence in said game process;
e. presenting said at least one intergame jackpot event to said player;
f. making said at least one intergame jackpot event available to said player as part of an interaction with said game process;
g. tracking each happening of said multiple event occurrence in said game process for said player;
h. retaining said at least one intergame jackpot event for said player without said at least one jackpot event being affected by actions of others for at least so long as said player continues to interact with said game process; and
i. paying said player a jackpot amount upon said player attaining a specified number of said multiple event occurrences in said game process.

30. A method of gaming to achieve extended player retention as described in claim 29 wherein said step of retaining said at least one intergame jackpot event for said player without said at least one jackpot event being affected by actions of others for at least so long as said player continues to interact with said game process comprises the step of resetting said at least one intergame jackpot event after accomplishing said step of paying said player a jackpot amount upon said player attaining a specified number of said multiple event occurrences in said game process.

31. A method of gaming to achieve extended player retention as described in claim 29 wherein said step of retaining said at least one intergame jackpot event for said player without said at least one jackpot event being affected by actions of others for at least so long as said player continues to interact with said game process comprises the step of resetting said at least one intergame jackpot event only after accomplishing said step of paying said player a jackpot amount upon said player attaining a specified number of said multiple event occurrences in said game process.

32. A method of gaming to achieve extended player retention as described in claim 29 wherein said step of providing a particular game process to a player comprises the steps of:
a. instituting an individual game for said player;
b. concluding said individual game for said player; and
c. reinstituting another individual game for said player as part of said game process,
and wherein said step of retaining said at least one intergame jackpot event for said player without said at least one jackpot event being affected by actions of others for at least so long as said player continues to interact with said game process comprises the step of carrying said at least one intergame jackpot event across said step of concluding said individual game for said player and said step of reinstituting another individual game for said player as part of said game process.

33. A method of gaming to achieve extended player retention as described in claim 29 wherein said step of associating said at least one intergame jackpot event with a multiple event occurrence in said game process comprises the step of associating said at least one intergame jackpot event with similar game occurrences in said game process.

34. A method of gaming to achieve extended player retention as described in claim 29 wherein said step of tracking each happening of said multiple event occurrence in said game process for said player comprises the step of automatically counting each happening of said multiple event occurrence in said game process for said player.

35. A method of gaming to achieve extended player retention as described in claim 29 wherein said step of tracking each happening of said multiple event occurrence in said game process for said player comprises the step of automatically counting down the remaining required number of said multiple event occurrences in said game process for said player.

36. A method of gaming to achieve extended player retention as described in claim 29, 34, or 35 wherein said step of tracking each happening of said multiple event occurrence in said game process for said player comprises the step of substantially continuously indicating a jackpot status to said player.

37. A method of gaming to achieve extended player retention as described in claim 29 wherein said step of retaining said at least one intergame jackpot event for said player without said at least one jackpot event being affected by actions of others for at least so long as said player continues to interact with said game process comprises the step of maintaining said at least one intergame jackpot event for said player with no time limit on actions in said game process.

38. A method of gaming to achieve extended player retention as described in claim 29 wherein said step of retaining said at least one intergame jackpot event for said player without said at least one jackpot event being affected by actions of others for at least so long as said player continues to interact with said game process comprises the steps of:
a. establishing a time limit for said player to act in said game process;
b. timing the time between actions by said player in said game process; and
c. resetting said at least one jackpot event upon said time limit being reached without an action being taken in said game process by said player.

39. A method of gaming to achieve extended player retention as described in claim 29 wherein said step of retaining said at least one intergame jackpot event for said player without said at least one jackpot event being affected by actions of others for at least so long as said player continues to interact with said game process comprises the step of periodically requiring specified events in said game process from said player in order to avoid a step of resetting said at least one jackpot event in said game process.

40. A method of gaming to achieve extended player retention as described in claim 38 or 39 wherein said step of retaining said at least one intergame jackpot event for said player without said at least one jackpot event being affected by actions of others for at least so long as said player continues to interact with said game process further comprises the steps of:
a. warning said player of an imminent occurrence of said step of resetting said at least one jackpot event; and
b. providing said player an opportunity to to take an action to avoid the occurrence of said step of resetting said at least one jackpot event

41. A method of gaming to achieve extended player retention as described in claim 39 wherein said step of periodically requiring specified events in said game process from said player in order to avoid a step of resetting said at least one jackpot event in said game process comprises the step of requiring specified events in said game process from said player selected from a group consisting of: playing said game process within a specified time, making a maximum bet in said game process, taking any action indicating that game is still being played, taking a randomly generated action in said game process.

42. A game device to achieve extended player retention comprising:
a. a game generator capable of providing a particular game process to a player;
b. a player interaction element through which said player can participate in said game process;
c. an intergame jackpot standards element responsive to said game process;
d. a multiple event tracker responsive to events within said game process;
e. a comparator responsive to said intergame jackpot standards element and said multiple event tracker;
f. a player jackpot status display responsive to said multiple event tracker without said intergame jackpot event being affected by actions of others for at least so long as a player continues to interact with said game process;
g. an intergame jackpot status retainer responsive to said multiple event tracker; and
h. an intergame jackpot payout element responsive to said comparator.

43. A game device to achieve extended player retention as described in claim 42 wherein said intergame jackpot status retainer responsive to said multiple event tracker comprises a jackpot reset responsive to said intergame jackpot payout element.

44. A game device to achieve extended player retention as described in claim 42 wherein said intergame jackpot status retainer responsive to said multiple event tracker comprises a jackpot reset responsive only to said intergame jackpot payout element.

45. A game device to achieve extended player retention as described in claim 42 wherein said game generator capable of providing a particular game process to a player comprises:
a. a game initiator,
b. a game conclusion element; and
c. a game reinitiator,
and wherein said intergame jackpot status retainer responsive to said multiple event tracker comprises a jackpot carryover which is unaffected by operation of either said game conclusion element or said game reinitiator.

46. A game device to achieve extended player retention as described in claim 42 wherein said multiple event tracker responsive to events within said game process comprises a similar game occurrence tracker.

47. A game device to achieve extended player retention as described in claim 42 wherein said multiple event tracker responsive to events within said game process comprises an automatic event counter.

48. A game device to achieve extended player retention as described in claim 42 wherein said multiple event tracker responsive to events within said game process comprises an automatic event decrementer.

49. A game device to achieve extended player retention as described in claim 42, 47, or 48 wherein said multiple event tracker responsive to events within said game process comprises a substantially continuous player display.

50. A game device to achieve extended player retention as described in claim 42 wherein said intergame jackpot status retainer responsive to said multiple event tracker comprises a time unrestricted element.

51. A game device to achieve extended player retention as described in claim 42 wherein said intergame jackpot status retainer responsive to said multiple event tracker comprises:
a. a time limit memory element;
b. a timer; and
c. a jackpot reset responsive to said timer and said time limit memory element.

52. A game device to achieve extended player retention as described in claim 42 wherein said intergame jackpot status retainer responsive to said multiple event tracker comprises a periodic event determiner.

53. A game device to achieve extended player retention as described in claim 51 or 52 and further comprising:
a. a jackpot reset alarm; and
b. a player jackpot reset-avoidance information display.

54. A game device to achieve extended player retention as described in claim 52 wherein said periodic event determiner is selected from a group consisting of: a game process event timer, a maximum bet determiner, a player confirmation element, and a random event generator.

55. A game device to achieve extended player retention as described in claim 42 wherein said intergame jackpot status retainer responsive to said multiple event tracker comprises an event memory element.

56. A method of gaming to achieve extended player retention comprising the steps of:
a. providing a particular game process to a player;
b. involving said player in some aspect of said game process;
c. establishing at least one jackpot event in said game process;
d. associating said at least one jackpot event with said game process;
e. presenting said at least one jackpot event to said player;
f. making said at least one jackpot event available to said player as part of an interaction with said game process;
g. indicating a distance said player is from said at least one jackpot event to said player;
h. decrementing said distance said player is from said at least one jackpot event as a result of events which occur in said game process to create a decremented distance said player is from said at least one jackpot event;
i. indicating said decremented distance said player is from said at least one jackpot event to said player; and
j. paying said player a jackpot amount upon said player attaining said at least one jackpot event in said game process.

57. A method of gaming to achieve extended player retention as described in claim 56 wherein said step of indicating said decremented distance said player is from said at least one jackpot event to said player comprises the step of substantially continuously displaying said decremented distance said player is from said at least one jackpot event to said player.

58. A method of gaming to achieve extended player retention as described in claim 56 wherein said step of indicating said decremented distance said player is from said at least one jackpot event to said player comprises the step of automatically counting down the remaining distance said player is from said at least one jackpot event for said player.

59. A method of gaming to achieve extended player retention as described in claim 56 wherein said step of establishing at least one jackpot event in said game process comprises the step of establishing a plurality of jackpot events in said game process, wherein said step of presenting said at least one jackpot event to said player comprises the step of presenting a plurality of jackpot events to said player, wherein said step of making said at least one jackpot event available to said player as part of an interaction with said game process comprises the step of making said plurality of jackpot events available to said player as part of an interaction with said game process, wherein said step of indicating a distance said player is from said at least one jackpot event to said player comprises the step of indicating distances said player is from said plurality of jackpot events to said player, wherein said step of decrementing said distance said player is from said at least one jackpot event as a result of events which occur in said game process to create a decremented distance said player is from said at least one jackpot event comprises the step of decrementing said distance said player is from each of said plurality of jackpot events as a result of events which occur in said game process to create a plurality of decremented distances said player is from each of said jackpot events, and wherein said step of indicating said decremented distance said player is from said at least one jackpot event to said player comprises the step of indicating said decremented distances said player is from each of said jackpot events to said player.

60. A method of gaming to achieve extended player retention as described in claim 59 wherein said step of indicating said decremented distances said player is from each of said jackpot events to said player comprises the step of substantially simultaneously indicating each of said decremented distances said player is from each of said jackpot events to said player.

61. A method of gaming to achieve extended player retention as described in claim 56, 59, or 60 wherein said step of indicating said decremented distance said player is from said at least one jackpot event to said player comprises the step of automatically counting down the remaining distance said player is from said at least one jackpot event for said player.

62. A game device to achieve extended player retention comprising:
a. a game generator capable of providing a particular game process to a player;
b. a player interaction element through which said player can participate in said game process;
c. a jackpot standards element responsive to said game process;
d. a multiple event tracker responsive to events within said game process;
e. a jackpot distance calculation element responsive to said jackpot standards element and said game process;
f. a jackpot distance memory element responsive to said jackpot distance calculation element;
g. a player jackpot distance display responsive to said jackpot distance memory element;
h. a jackpot distance decrementer responsive to said game process and to which said jackpot distance memory element is responsive; and
i. a jackpot payout element responsive to said jackpot distance calculation element.

63. A game device to achieve extended player retention as described in claim 62 wherein said player jackpot distance display responsive to said jackpot distance memory element comprises a substantially continuous player jackpot distance display responsive to said jackpot distance memory element.

64. A game device to achieve extended player retention as described in claim 62 wherein said jackpot distance decrementer responsive to said game process and to which said jackpot distance memory element is responsive comprises an automatic event decrementer responsive to said game process and to which said jackpot distance memory element is responsive.

65. A game device to achieve extended player retention as described in claim 62 wherein said jackpot standards element responsive to said game process comprises a plurality of jackpot standards elements responsive to said game process, wherein said multiple event tracker responsive to events within said game process comprises a plurality of multiple event trackers responsive to events within said game process, wherein said jackpot distance calculation element responsive to said jackpot standards element and said game process comprises a plurality of jackpot distance calculation elements responsive to said jackpot standards element and said game process, wherein said jackpot distance memory element responsive to said jackpot distance calculation element comprises a plurality of jackpot distance memory elements responsive to said jackpot distance calculation element, wherein said player jackpot distance display responsive to said jackpot distance memory element comprises a plurality of jackpot distance displays responsive to said plurality of said jackpot distance memory elements, and wherein said jackpot distance decrementer responsive to said game process and to which said jackpot distance memory element is responsive comprises a plurality of jackpot distance decrementers responsive to said game process and to which said jackpot distance memory elements are responsive.

66. A game device to achieve extended player retention as described in claim 65 wherein said plurality of jackpot distance displays responsive to said plurality of said jackpot distance memory elements comprise a plurality of substantially simultaneous jackpot distance displays responsive to said plurality of said jackpot distance memory elements.

67. A game device to achieve extended player retention as described in claim 62, 65, or 66 wherein said jackpot distance decrementer responsive to said game process and to which said jackpot distance memory element is responsive comprises at least one automatic event decrementer responsive to said game process and to which said jackpot distance memory element is responsive.

68. A method of gaming to achieve extended player retention comprising the steps of:
a. providing a particular game process to a player;
b. involving said player in some aspect of said game process;
c. establishing at least one common-occurrence jackpot event based upon at least one relatively common event in said game process;
d. intrinsically associating said at least one common-occurrence jackpot event with said game process;
e. intrinsically presenting said at least one common-occurrence jackpot event to said player as part of said game process;
f. making said at least one common-occurrence jackpot event available to said player as part of an interaction with said game process; and
g. paying said player a jackpot amount upon said player attaining said common-occurrence jackpot event in said game process.

69. A method of gaming to achieve extended player retention as described in claim 68 wherein said step of establishing at least one common-occurrence jackpot event based upon at least one relatively common event in said game process comprises the step of establishing at least one jackpot event based upon a game event in said game process selected from a group of game events consisting of:
game events having a probability of greater than about 100 in 10,000,
game events having a probability of greater than about 110 in 10,000,
game events having a probability of greater than about 130 in 10,000,
game events having a probability of greater than about 220 in 10,000,
game events having a probability of greater than about 550 in 10,000,
game events having a probability of greater than about 700 in 10,000,
game events having a probability of greater than about 1200 in 10,000,
game events having a probability of greater than about 2000 in 10,000, and
game events having a probability of greater than about 5000 in 10,000.

70. A method of gaming to achieve extended player retention as described in claim 68 wherein said step of establishing at least one common-occurrence jackpot event based upon at least one relatively common event in said game process comprises the step of establishing at least one jackpot event based upon a game event in said game process selected from a group of game events consisting of: a straight game event, a flush game event, a full house game event, a three-of-a-kind game event, a two pair game event, a jacks-or-better game event, a queens-or-better game event, a kings-or-better game event, an aces-or-better game event, and a losing game event.

71. A method of gaming to achieve extended player retention as described in claim 68 wherein said step of intrinsically associating said at least one common-occurrence jackpot event with said game process comprises the step of associating said at least one common-occurrence jackpot event with said game process as part of a minimum bet or better in said gaming process.

72. A method of gaming to achieve extended player retention as described in claim 68 wherein said step of intrinsically associating said at least one common-occurrence jackpot event with said game process comprises the step of automatically associating said at least one common-occurrence jackpot event with said game process.

73. A method of gaming to achieve extended player retention as described in claim 68 wherein said step of intrinsically associating said at least one common-occurrence jackpot event with said game process comprises the step of automatically associating said at least one common-occurrence jackpot event with said game process on an initial play in said game process.

74. A method of gaming to achieve extended player retention as described in claim 68 and further comprising the step of maintaining said at least one common-occurrence jackpot event for said player with no time limit on actions in said game process.

75. A method of gaming to achieve extended player retention as described in claim 68 and further comprising the steps of:
a. establishing a time limit for said player to act in said game process;
b. timing the time between actions by said player in said game process; and
c. resetting said at least one common-occurrence jackpot event upon said time limit being reached without an action being taken in said game process by said player.

76. A method of gaming to achieve extended player retention as described in claim 68 and further comprising the step of periodically requiring specified events in said game process from said player in order to avoid a step of resetting said at least one common-occurrence jackpot event in said game process.

77. A game device to achieve extended player retention comprising:
a. a game generator capable of providing a particular game process to a player;
b. a player interaction element through which said player can participate in said game process;
c. a common-occurrence jackpot standards element responsive to said game process and based upon at least one relatively common event in said game process;
d. an intrinsic jackpot association element responsive to said common-occurrence jackpot standards element and to events within said game process;
e. a player jackpot display responsive to said common-occurrence jackpot standards element; and
f. a jackpot payout element responsive to said common-occurrence jackpot standards element.

78. A game device to achieve extended player retention as described in claim 77 wherein said common-occurrence jackpot standards element responsive to said game process and based upon at least one relatively common event in said game process comprises a jackpot standards element utilizing game events in said game process selected from a group of game events consisting of:
game events having a probability of greater than about 100 in 10,000,
game events having a probability of greater than about 110 in 10,000,
game events having a probability of greater than about 130 in 10,000,
game events having a probability of greater than about 220 in 10,000,
game events having a probability of greater than about 550 in 10,000,
game events having a probability of greater than about 700 in 10,000,
game events having a probability of greater than about 1200 in 10,000,
game events having a probability of greater than about 2000 in 10,000, and
game events having a probability of greater than about 5000 in 10,000.

79. A game device to achieve extended player retention as described in claim 77 wherein said common-occurrence jackpot standards element responsive to said game process and based upon at least one relatively common event in said game process comprises a jackpot standards element utilizing game events in said game process selected from a group of game events consisting of: a straight game event, a flush game event, a full house game event, a three-of-a-kind game event, a two pair game event, a jacks-or-better game event, a queens-or-better game event, a kings-or-better game event, an aces-or-better game event, and a losing game event.

80. A game device to achieve extended player retention as described in claim 77 wherein said intrinsic jackpot association element responsive to said common-occurrence jackpot standards element and to events within said game process comprises a minimum bet or better jackpot association element responsive to said common-occurrence jackpot standards element and to events within said game process.

81. A game device to achieve extended player retention as described in claim 77 wherein said intrinsic jackpot association element responsive to said common-occurrence jackpot standards element and to events within said game process comprises an automatic jackpot association element responsive to said common-occurrence jackpot standards element and to events within said game process.

82. A game device to achieve extended player retention as described in claim 77 wherein said intrinsic jackpot association element responsive to said common-occurrence jackpot standards element and to events within said game process comprises an automatic initial play element responsive to said common-occurrence jackpot standards element and to events within said game process.

83. A game device to achieve extended player retention as described in claim 77 and further comprising a time unrestricted element to which said intrinsic jackpot association element is responsive.

84. A game device to achieve extended player retention as described in claim 77 and further comprising:
a. a time limit memory element;
b. a timer; and
c. a jackpot reset responsive to said timer and said time limit memory element, to which said intrinsic jackpot association element is responsive.

85. A game device to achieve extended player retention as described in claim 77 and further comprising a periodic event determiner to which said intrinsic jackpot association element is responsive.

86. A method of gaming to achieve extended player retention comprising the steps of:
a. providing a game process to a player;
b. involving said player in some aspect of said game process;
c. establishing at least one non-consecutive, repetitive-occurrence jackpot event in said game process;
d. associating said at least one non-consecutive, repetitive-occurrence jackpot event with said game process;
e. presenting said at least one non-consecutive, repetitive-occurrence jackpot event to said player;
f. making said at least one non-consecutive, repetitive-occurrence jackpot event available to said player as part of an interaction with said game process; and
g. paying said player a jackpot amount upon said player attaining said non-consecutive, repetitive-occurrence jackpot event in said game process.

87. A method of gaming to achieve extended player retention comprising the steps of:
a. providing a poker game process to a player;
b. involving said player in some aspect of said poker game process;
c. establishing at least one repetitive-occurrence jackpot event in said poker game process;
d. associating said at least one repetitive-occurrence jackpot event with said poker game process;
e. presenting said at least one repetitive-occurrence jackpot event to said player;
f. making said at least one repetitive-occurrence jackpot event available to said player as part of an interaction with said poker game process; and
g. paying said player a jackpot amount upon said player attaining said repetitive-occurrence jackpot event in said poker game process.

88. A method of gaming to achieve extended player retention comprising the steps of:
a. providing a keno game process to a player;
b. involving said player in some aspect of said keno game process;
c. establishing at least one repetitive-occurrence jackpot event in said keno game process;
d. associating said at least one repetitive-occurrence jackpot event with said keno game process;
e. presenting said at least one repetitive-occurrence jackpot event to said player;
f. making said at least one repetitive-occurrence jackpot event available to said player as part of an interaction with said keno game process; and
g. paying said player a jackpot amount upon said player attaining said repetitive-occurrence jackpot event in said keno game process.

89. A method of gaming to achieve extended player retention comprising the steps of:
a. providing a slots game process to a player;
b. involving said player in some aspect of said slots game process;
c. establishing at least one repetitive-occurrence jackpot event in said slots game process;
d. associating said at least one repetitive-occurrence jackpot event with said slots game process;
e. presenting said at least one repetitive-occurrence jackpot event to said player;
f. making said at least one repetitive-occurrence jackpot event available to said player as part of an interaction with said slots game process; and
g. paying said player a jackpot amount upon said player attaining said repetitive-occurrence jackpot event in said slots game process.

90. A method of gaming to achieve extended player retention as described in claim 86, 87, 88, or 89 wherein said step of establishing at least one repetitive-occurrence jackpot event comprises the step of establishing at least one high event occurrence number jackpot event.

91. A method of gaming to achieve extended player retention as described in claim 90 wherein said step of establishing at least one high event occurrence number jackpot event comprises the step of establishing a jackpot event selected from a group consisting of:
a jackpot event requiring at least about 2 non-consecutive game event occurrences,
a jackpot event requiring at least about 5 non-consecutive game event occurrences,
a jackpot event requiring at least about 5 game event occurrences,
a jackpot event requiring at least about 10 game event occurrences,
a jackpot event requiring at least about 20 game event occurrences,
a jackpot event requiring at least about 40 game event occurrences,
a jackpot event requiring at least about 40 game event occurrences,
a jackpot event requiring at least about 50 game event occurrences,
a jackpot event requiring at least about 60 game event occurrences,
a jackpot event requiring at least about 80 game event occurrences, and
a jackpot event requiring at least about 100 game event occurrences.

92. A method of gaming to achieve extended player retention as described in claim 86, 87, 88, or 89 wherein said step of providing a game process to a player comprises the steps of:
a. instituting an individual game for said player;
b. concluding said individual game for said player; and
c. reinstituting another individual game for said player as part of said game process,
and wherein said step of establishing at least one repetitive-occurrence jackpot event comprises the step of carrying said at least one repetitive-occurrence jackpot event across said step of concluding said individual game for said player and said step of reinstituting another individual game for said player as part of said game process.

93. A method of gaming to achieve extended player retention as described in claim 86, 87, 88, or 89 wherein said repetitive-occurrence jackpot event is comprised of multiple game event occurrences, and further comprising the step of automatically counting multiple game event occurrences in said game process for said player.

94. A method of gaming to achieve extended player retention as described in claim 93 and further comprising the step of automatically retaining said count of said multiple game event occurrences in said game process for said player throughout accomplishing said step of involving said player in some aspect of said game process.

95. A method of gaming to achieve extended player retention as described in claim 94 and further comprising the step of comparing said count of said multiple game event occurrences to said at least one non-consecutive, repetitive-occurrence jackpot event in said game process.

96. A game device to achieve extended player retention comprising:
a. a game generator capable of providing a particular game process to a player;
b. a player interaction element through which said player can participate in said game process;
c. at least one non-consecutive, repetitive-occurrence jackpot standards element responsive to said game process;
d. a player jackpot status display responsive to said at least one non-consecutive, repetitive-occurrence jackpot standards element; and
e. a jackpot payout element responsive to said at least one non-consecutive, repetitive-occurrence jackpot standards element.

97. A game device to achieve extended player retention comprising:
a. a poker game generator capable of providing a poker game process to a player;
b. a player interaction element through which said player can participate in said poker game process;
c. at least one repetitive-occurrence jackpot standards element responsive to said poker game process;
d. a player jackpot status display responsive to said at least one repetitive-occurrence jackpot standards element; and
e. a jackpot payout element responsive to said at least one repetitive-occurrence jackpot standards element.

98. A game device to achieve extended player retention comprising:
a. a keno game generator capable of providing a keno game process to a player;
b. a player interaction element through which said player can participate in said keno game process;
c. at least one repetitive-occurrence jackpot standards element responsive to said keno game process;
d. a player jackpot status display responsive to said at least one repetitive-occurrence jackpot standards element; and
e. a jackpot payout element responsive to said at least one repetitive-occurrence jackpot standards element.

99. A game device to achieve extended player retention comprising:
a. a slots game generator capable of providing a slots game process to a player;
b. a player interaction element through which said player can participate in said slots game process;
c. at least one repetitive-occurrence jackpot standards element responsive to said slots game process;
d. a player jackpot status display responsive to said at least one repetitive-occurrence jackpot standards element; and
e. a jackpot payout element responsive to said at least one repetitive-occurrence jackpot standards element.

100. A game device to achieve extended player retention as described in claim 96, 97, 98, or 99 wherein said at least one repetitive-occurrence jackpot standards element responsive to said game process comprises at least one high event occurrence number jackpot event element responsive to said game process.

101. A game device to achieve extended player retention as described in claim 100 wherein said at least one high event occurrence number jackpot event element responsive to said game process comprises a high event occurrence number jackpot event element selected from a group consisting of:
a jackpot event element requiring at least about 2 non-consecutive game event occurrences,
a jackpot event element requiring at least about 5 non-consecutive game event occurrences,
a jackpot event element requiring at least about 5 game event occurrences,
a jackpot event element requiring at least about 10 game event occurrences,
a jackpot event element requiring at least about 20 game event occurrences,
a jackpot event element requiring at least about 40 game event occurrences,
a jackpot event element requiring at least about 50 game event occurrences,
a jackpot event element requiring at least about 60 game event occurrences,
a jackpot event element requiring at least about 80 game event occurrences, and
a jackpot event element requiring at least about 100 game event occurrences.

102. A game device to achieve extended player retention as described in claim 96, 97, 98, or 99 wherein said game generator capable of providing a particular game process to a player comprises:
a. a game initiator;
b. a game conclusion element; and
c. a game reinitiator,
and wherein said at least one repetitive-occurrence jackpot standards element responsive to said game process comprises a jackpot carryover which is unaffected by operation of either said game conclusion element or said game reinitiator.

103. A game device to achieve extended player retention as described in claim 96, 97, 98, or 99 and further comprising an automatic repetitive event counter.

104. A game device to achieve extended player retention as described in claim 103 and further comprising a repetitive event count memory element responsive to said automatic repetitive event counter.

105. A method of gaming to achieve extended player retention comprising the steps of:
a. providing a particular game process to a player;
b. involving said player in some aspect of said game process;
c. establishing a plurality of repetitive-occurrence jackpot events in said game process;
d. associating said plurality of repetitive-occurrence jackpot events with said game process;
e. concurrently presenting said plurality of repetitive-occurrence jackpot events to said player as part of said game process;
f. making said plurality of repetitive-occurrence jackpot events available to said player as part of an interaction with said game process; and
g. paying said player a jackpot amount upon said player attaining at least one of said plurality of repetitive-occurrence jackpot events in said game process.

106. A method of gaming to achieve extended player retention as described in claim 105 wherein each of said repetitive-occurrence jackpot events is based upon a different game event in said game process and wherein said step of establishing a plurality of repetitive-occurrence jackpot events in said game process comprises the step of automatically counting each of said different game events in said game process.

107. A method of gaming to achieve extended player retention as described in claim 105 wherein said step of making said plurality of repetitive-occurrence jackpot events available to said player as part of an interaction with said game process comprises the step of substantially continuously displaying the status of at least one of said repetitive-occurrence jackpot events in said game process to said player.

108. A method of gaming to achieve extended player retention as described in claim 105 wherein said step of making said plurality of repetitive-occurrence jackpot events available to said player as part of an interaction with said game process comprises the step of substantially continuously displaying the status of a plurality of said plurality of repetitive-occurrence jackpot events in said game process to said player.

109. A method of gaming to achieve extended player retention as described in claim 105 wherein said step of making said plurality of repetitive-occurrence jackpot events available to said player as part of an interaction with said game process comprises the step of substantially continuously displaying the status of all of said plurality of repetitive-occurrence jackpot events in said game process to said player.

110. A method of gaming to achieve extended player retention as described in claim 105 wherein said step of establishing a plurality of repetitive-occurrence jackpot events in said game process comprises the step of selecting a plurality of staggered probability repetitive-occurrence jackpot events for said game process.

111. A method of gaming to achieve extended player retention as described in claim 110 wherein said step of selecting a plurality of staggered probability repetitive-occurrence jackpot events for said game process comprises the step of establishing a plurality of staggered probability repetitive-occurrence jackpot events for said game process such that at least one of said staggered probability repetitive-occurrence jackpot events is typically within a continued play tolerance for a typical player.

112. A method of gaming to achieve extended player retention as described in claim 111 wherein said step of establishing a plurality of staggered probability repetitive-occurrence jackpot events for said game process such that at least one of said staggered probability repetitive-occurrence jackpot events is typically within a continued play tolerance for a typical player comprises the step of utilizing staggered probability repetitive-occurrence jackpot events such that at least one is typically within a number of optimal repetitive events selected from a group consisting of:
less than about 5 additional repetitive events,
less than about 10 additional repetitive events,
less than about 15 additional repetitive events,
less than about 20 additional repetitive events,
less than about 50 additional repetitive events,
less than about 100 additional repetitive events,
less than about 10 additional repetitive events for each machine participating in said jackpot event,
less than about 15 additional repetitive events for each machine participating in said jackpot event,
less than about 20 additional repetitive events for each machine participating in said jackpot event,
less than about 50 additional repetitive events for each machine participating in said jackpot event,
less than about 100 additional repetitive events for each machine participating in said jackpot event,
less than a number of repetitive events which represents minimum bets of less than about $1.00,
less than a number of repetitive events which represents minimum bets of less than about $5.00,
less than a number of repetitive events which represents minimum bets of less than about $10.00,
less than a number of repetitive events which represents minimum bets of less than about $15.00,
less than a number of repetitive events which represents minimum bets of less than about $20.00,
less than a number of repetitive events which represents minimum bets of less than about $25.00,
less than a number of repetitive events which represents minimum bets of less than about $50.00,
less than a number of repetitive events which represents minimum bets of less than about $100.00,
less than a number of repetitive events which represents minimum bets of less than about $500.00, and
less than a number of repetitive events which represents minimum bets of less than about $1000.00.

113. A game device to achieve extended player retention comprising:
a. a game generator capable of providing a game process to a player;
b. a player interaction element through which said player can participate in said game process;
c. a plurality of concurrent repetitive-occurrence jackpot standards elements responsive to said game process;
d. at least one concurrent player jackpot status display responsive to said plurality of concurrent repetitive-occurrence jackpot standards elements; and
e. a jackpot payout element responsive to said plurality of concurrent repetitive-occurrence jackpot standards elements.

114. A game device to achieve extended player retention as described in claim 113 wherein said plurality of concurrent repetitive-occurrence jackpot standards elements are each based upon a different game event in said game process and wherein said at least one concurrent player jackpot status display responsive to said plurality of concurrent repetitive-occurrence jackpot standards elements comprises at least one automatic event counter for each different game event.

115. A game device to achieve extended player retention as described in claim 113 wherein said at least one concurrent player jackpot status display responsive to said plurality of concurrent repetitive-occurrence jackpot standards elements comprises at least one substantially continuous jackpot status display.

116. A game device to achieve extended player retention as described in claim 113 wherein said at least one concurrent player jackpot status display responsive to said plurality of concurrent repetitive-occurrence jackpot standards elements comprises a plurality of substantially continuous jackpot status displays.

117. A game device to achieve extended player retention as described in claim 113 wherein said plurality of concurrent repetitive-occurrence jackpot standards elements are each based upon a different game event in said game process and wherein said at least one concurrent player jackpot status display responsive to said plurality of concurrent repetitive-occurrence jackpot standards elements comprises a substantially continuous jackpot status displays for each of said different game events in said game process.

118. A game device to achieve extended player retention as described in claim 113 wherein said plurality of concurrent repetitive-occurrence jackpot standards elements responsive to said game process comprises a staggered probability repetitive-occurrence jackpot event element.

119. A game device to achieve extended player retention as described in claim 118 wherein said staggered probability repetitive-occurrence jackpot event element comprises a continued play player tolerance estimation element.

120. A game device to achieve extended player retention as described in claim 119 wherein said continued play player tolerance estimation element comprises a continued play player tolerance estimation element utilizing jackpot events such that at least one is typically within a number of optimal repetitive events selected from a group consisting of:
less than about 10 additional repetitive events,
less than about 15 additional repetitive events,
less than about 20 additional repetitive events,
less than about 50 additional repetitive events,
less than about 100 additional repetitive events,
less than about 10 additional repetitive events for each machine participating in said jackpot event,
less than about 15 additional repetitive events for each machine participating in said jackpot event,
less than about 20 additional repetitive events for each machine participating in said jackpot event,
less than about 50 additional repetitive events for each machine participating in said jackpot event,
less than about 100 additional repetitive events for each machine participating in said jackpot event,
less than a number of repetitive events which represents minimum bets of less than about $5.00,
less than a number of repetitive events which represents minimum bets of less than about $10.00,
less than a number of repetitive events which represents minimum bets of less than about $15.00,
less than a number of repetitive events which represents minimum bets of less than about $20.00,
less than a number of repetitive events which represents minimum bets of less than about $25.00,
less than a number of repetitive events which represents minimum bets of less than about $50.00, and
less than a number of repetitive events which represents minimum bets of less than about $100.00.

121. A method of gaming to achieve extended player retention comprising the steps of:
a. providing a repetitively reinstituted game process to a player;
b. involving said player in some aspect of said repetitively reinstituted game process;
c. establishing at least one jackpot event in said repetitively reinstituted game process wherein said jackpot event has an initial probability of occurring;
d. associating said at least one jackpot event with said repetitively reinstituted game process;
e. presenting said at least one jackpot event to said player as part of said repetitively reinstituted game process;
f. making said at least one jackpot event available to said player as part of an interaction with said repetitively reinstituted game process;
g. altering the probability of said at least one jackpot event occurring based upon actions taken by said player to create an altered probability;
h. retaining said altered probability when said repetitively reinstituted game process is reinstituted; and
i. paying a jackpot amount upon a player attaining said at least one jackpot event in said repetitively reinstituted game process.

122. A method of gaming to achieve extended player retention as described in claim 121 wherein said step of presenting said at least one jackpot event to said player as part of said repetitively reinstituted game process comprises the step of altering a distance said player is from said at least one jackpot event in response to said step of altering the probability of said at least one jackpot event occurring based upon actions taken by said player to create an altered probability.

123. A method of gaming to achieve extended player retention as described in claim 122 wherein said step of altering a distance said player is from said at least one jackpot event in response to said step of altering the probability of said at least one jackpot event occurring based upon actions taken by said player to create an altered probability comprises the step of decreasing a distance said player is from said at least one jackpot event in response to said step of altering the probability of said at least one jackpot event occurring based upon actions taken by said player to create an altered probability.

124. A method of gaming to achieve extended player retention as described in claim 121 wherein said step of altering the probability of said at least one jackpot event occurring based upon actions taken by said player to create an altered probability comprises the step of tracking prior game events in said game process for said player.

125. A method of gaming to achieve extended player retention as described in claim 121 wherein said step tracking prior game events in said game process for said player comprises the step of automatically counting down a number of multiple event occurrences in said game process for said player.

126. A method of gaming to achieve extended player retention as described in claim 121 wherein said step of providing a repetitively reinstituted game process to a player comprises the steps of:
a. instituting an individual game for said player;
b. concluding said individual game for said player; and
c. reinstituting another individual game for said player as part of said game process,
and wherein said step of making said at least one jackpot event available to said player as part of an interaction with said repetitively reinstituted game process comprises the step of carrying said at least one jackpot event across said step of concluding said individual game for said player and said step of reinstituting another individual game for said player as part of said game process.

127. A game device to achieve extended player retention comprising:
a. a repetitive game generator capable of providing a repetitively reinstituted game process to a player;
b. a player interaction element through which said player can participate in said repetitively reinstituted game process;
c. at least one jackpot standards element responsive to said repetitively reinstituted game process wherein said jackpot standards element has an initial probability of occurrence associated with it;
d. a jackpot probability alteration element which is responsive to said repetitively reinstituted game process;
e. a player jackpot status display responsive to said jackpot probability alteration element;
f. a jackpot probability retainer responsive to said jackpot probability alteration element and which acts across different occurrences of said repetitively reinstituted game process; and
g. a jackpot payout element responsive to said at least one jackpot standards element.

128. A game device to achieve extended player retention as described in claim 127 wherein said jackpot probability alteration element which is responsive to said repetitively reinstituted game process comprises an automatic jackpot distance alteration element which is responsive to said repetitively reinstituted game process.

129. A game device to achieve extended player retention as described in claim 128 wherein said automatic jackpot distance alteration element which is responsive to said repetitively reinstituted game process comprises an automatic jackpot distance decrementer responsive to said game process.

130. A game device to achieve extended player retention as described in claim 127 wherein said jackpot probability alteration element which is responsive to said repetitively reinstituted game process comprises a prior game event tracker responsive to events within said game process.

131. A game device to achieve extended player retention as described in claim 130 wherein said prior game event tracker responsive to events within said game process comprises an automatic jackpot distance decrementer responsive to said game process.

132. A game device to achieve extended player retention as described in claim 127 wherein said repetitive game generator capable of providing a repetitively reinstituted game process to a player comprises:
a. a game initiator,
b. a game conclusion element; and
c. a game reinitiator,
and wherein said at least one jackpot standards element responsive to said repetitively reinstituted game process comprises a jackpot carryover which is unaffected by operation of either said game conclusion element or said game reinitiator.

133. A method of gaming to achieve extended player retention comprising the steps of:
a. providing a game process to a player having winning circumstances and losing circumstances;
b. involving said player in some aspect of said game process;
c. establishing at least one losing circumstance based jackpot event in said game process;
d. associating said at least one losing circumstance based jackpot event with said game process;
e. presenting said at least one losing circumstance based jackpot event to said player;
f. making said at least one losing circumstance based jackpot event available to said player as part of an interaction with said game process;
g. tracking each happening of said losing circumstance in said game process for said player; and
h. paying said player a jackpot amount upon said player attaining a specified number of said losing circumstances in said game process.

134. A method of gaming to achieve extended player retention as described in claim 133 wherein said step of establishing at least one losing circumstance based jackpot event in said game process comprises the step of establishing at least one no-win circumstance based jackpot event in said game process.

135. A method of gaming to achieve extended player retention as described in claim 133 wherein said step of establishing at least one losing circumstance based jackpot event in said game process comprises the step of establishing at least one common-occurrence based jackpot event in said game process.

136. A game device to achieve extended player retention comprising:
a. a game generator capable of providing a game process to a player wherein said game process has winning circumstances and losing circumstances;
b. a player interaction element through which said player can participate in said game process;
c. at least one losing circumstance jackpot standards element responsive to said game process;
d. a losing circumstance multiple event counter responsive to losing circumstances within said game process;
e. a comparator responsive to said losing circumstance jackpot standards element and said losing circumstance multiple event counter;
f. a player jackpot status display responsive to said losing circumstance multiple event counter; and
g. a jackpot payout element responsive to said comparator.

137. A game device to achieve extended player retention as described in claim 136 wherein said at least one losing circumstance jackpot standards element responsive to said game process comprises at least one no-win circumstance jackpot standards element.

138. A game device to achieve extended player retention as described in claim 136 wherein said at least one losing circumstance jackpot standards element responsive to said game process comprises at least one common-occurrence jackpot standards element.

139. A method of gaming to achieve extended player retention comprising the steps of:
a. providing a particular card game process to a player having at least a straight game outcome;
b. involving said player in some aspect of said card game process;
establishing at least one straight game outcome based jackpot event in said card game process;
d. associating said at least one straight game outcome based jackpot event with said card game process;
e. presenting said at least one straight game outcome based jackpot event to said player as part of said card game process;
f. making said at least one straight game outcome based jackpot event available to said player as part of an interaction with said card game process; and
g. paying said player a jackpot amount upon said player attaining said straight game outcome based jackpot event in said card game process.

140. A method of gaming to achieve extended player retention comprising the steps of:
a. providing a particular card game process to a player having at least a flush game outcome;
b. involving said player in some aspect of said card game process;
c. establishing at least one flush game outcome based jackpot event in said card game process;
d. associating said at least one flush game outcome based jackpot event with said card game process;
e. presenting said at least one flush game outcome based jackpot event to said player as part of said card game process;
f. making said at least one flush game outcome based jackpot event available to said player as part of an interaction with said card game process; and
g. paying said player a jackpot amount upon said player attaining said flush game outcome based jackpot event in said card game process.

141. A method of gaining to achieve extended player retention comprising the steps of:
a. providing a particular card game process to a player having at least a full house game outcome;
b. involving said player in some aspect of said card game process;
c. establishing at least one full house game outcome based jackpot event in said card game process;
d. associating said at least one fill house game outcome based jackpot event with said card game process;
e. presenting said at least one full house game outcome based jackpot event to said player as part of said card game process;
f. making said at least one full house game outcome based jackpot event available to said player as part of an interaction with said card game process; and
g. paying said player a jackpot amount upon said player attaining said full house game outcome based jackpot event in said card game process.

142. A method of gaming to achieve extended player retention comprising the steps of:
a. providing a particular card game process to a player having at least a three-of-a-kind game outcome;
b. involving said player in some aspect of said card game process;
c. establishing at least one three-of-a-kind game outcome based jackpot event in said card game process;
d. associating said at least one three-of-a-kind game outcome based jackpot event with said card game process;
e. presenting said at least one three-of-a-kind game outcome based jackpot event to said player as part of said card game process;
f. making said at least one three-of-a-kind game outcome based jackpot event available to said player as part of an interaction with said card game process; and
g. paying said player a jackpot amount upon said player attaining said three-of-a-kind game outcome based jackpot event in said card game process.

143. A method of gaming to achieve extended player retention comprising the steps of:
a. providing a particular card game process to a player having at least a two pair game outcome;
b. involving said player in some aspect of said card game process;
c. establishing at least one two pair game outcome based jackpot event in said card game process;
d. associating said at least one two pair game outcome based jackpot event with said card game process;
e. presenting said at least one two pair game outcome based jackpot event to said player as part of said card game process;
f. making said at least one two pair game outcome based jackpot event available to said player as part of an interaction with said card game process; and
g. paying said player a jackpot amount upon said player attaining said two pair game outcome based jackpot event in said card game process.

144. A method of gaming to achieve extended player retention comprising the steps of:
a. providing a particular card game process to a player having at least a jacks-or-better game outcome;
b. involving said player in some aspect of said card game process;
c. establishing at least one jacks-or-better game outcome based jackpot event in said card game process;
d. associating said at least one jacks-or-better game outcome based jackpot event with said card game process;
e. presenting said at least one jacks-or-better game outcome based jackpot event to said player as part of said card game process;
f. making said at least one jacks-or-better game outcome based jackpot event available to said player as part of an interaction with said card game process; and
g. paying said player a jackpot amount upon said player attaining said jacks-or-better game outcome based jackpot event in said card game process.

145. A method of gaming to achieve extended player retention comprising the steps of:
a. providing a particular card game process to a player having at least a queens-or-better game outcome;
b. involving said player in some aspect of said card game process;
c. establishing at least one queens-or-better game outcome based jackpot event in said card game process;
d. associating said at least one queens-or-better game outcome based jackpot event with said card game process;
e. presenting said at least one queens-or-better game outcome based jackpot event to said player as part of said card game process;
f. making said at least one queens-or-better game outcome based jackpot event available to said player as part of an interaction with said card game process; and
g. paying said player a jackpot amount upon said player attaining said queens-or-better game outcome based jackpot event in said card game process.

146. A method of gaming to achieve extended player retention comprising the steps of:
a. providing a particular card game process to a player having at least a kings-or-better game outcome;
b. involving said player in some aspect of said card game process;
c. establishing at least one kings-or-better game outcome based jackpot event in said card game process;
d. associating said at least one kings-or-better game outcome based jackpot event with said card game process;
e. presenting said at least one kings-or-better game outcome based jackpot event to said player as part of said card game process;
f. making said at least one kings-or-better game outcome based jackpot event available to said player as part of an interaction with said card game process; and
g. paying said player a jackpot amount upon said player attaining said kings-or-better game outcome based jackpot event in said card game process.

147. A method of gaming to achieve extended player retention comprising the steps of:
a. providing a particular card game process to a player having at least a aces-or-better game outcome;
b. involving said player in some aspect of said card game process;
c. establishing at least one aces-or-better game outcome based jackpot event in said card game process;
d. associating said at least one aces-or-better game outcome based jackpot event with said card game process;
e. presenting said at least one aces-or-better game outcome based jackpot event to said player as part of said card game process;
f. making said at least one aces-or-better game outcome based jackpot event available to said player as part of an interaction with said card game process; and
g. paying said player a jackpot amount upon said player attaining said aces-or-better game outcome based jackpot event in said card game process.

148. A game device to achieve extended player retention comprising:
a. a game generator capable of providing a particular card game process to a player wherein said card game process has at least a straight game outcome;
b. a player interaction element through which said player can participate in said card game process;
c. at least one straight game outcome based jackpot standards element responsive to said card game process;
d. a player jackpot status display responsive to said at least one straight game outcome based jackpot standards element; and
e. a jackpot payout element responsive to said at least one straight game outcome based jackpot standards element.

149. A game device to achieve extended player retention comprising:
a. a game generator capable of providing a particular card game process to a player wherein said card game process has at least a flush game outcome;
b. a player interaction element through which said player can participate in said card game process;
c. at least one flush game outcome based jackpot standards element responsive to said card game process;
d. a player jackpot status display responsive to said at least one flush game outcome based jackpot standards element; and
e. a jackpot payout element responsive to said at least one flush game outcome based jackpot standards element.

150. A game device to achieve extended player retention comprising:
a. a game generator capable of providing a particular card game process to a player wherein said card game process has at least a full house game outcome;
b. a player interaction element through which said player can participate in said card game process;
c. at least one full house game outcome based jackpot standards element responsive to said card game process;
d. a player jackpot status display responsive to said at least one full house game outcome based jackpot standards element; and
e. a jackpot payout element responsive to said at least one full house game outcome based jackpot standards element.

151. A game device to achieve extended player retention comprising:
a. a game generator capable of providing a particular card game process to a player wherein said card game process has at least a three-of-a-kind game outcome;
b. a player interaction element through which said player can participate in said card game process;
c. at least one three-of-a-kind game outcome based jackpot standards element responsive to said card game process;
d. a player jackpot status display responsive to said at least one three-of-a-kind game outcome based jackpot standards element; and
e. a jackpot payout element responsive to said at least one three-of-a-kind game outcome based jackpot standards element.

152. A game device to achieve extended player retention comprising:
a. a game generator capable of providing a particular card game process to a player wherein said card game process has at least a two pair game outcome;
b. a player interaction element through which said player can participate in said card game process;
c. at least one two pair game outcome based jackpot standards element responsive to said card game process;
d. a player jackpot status display responsive to said at least one two pair game outcome based jackpot standards element; and
e. a jackpot payout element responsive to said at least one two pair game outcome based jackpot standards element.

153. A game device to achieve extended player retention comprising:
a. a game generator capable of providing a particular card game process to a player wherein said card game process has at least a jacks-or-better game outcome;
b. a player interaction element through which said player can participate in said card game process;
c. at least one jacks-or-better game outcome based jackpot standards element responsive to said card game process;
d. a player jackpot status display responsive to said at least one jacks-or-better game outcome based jackpot standards element; and
e. a jackpot payout element responsive to said at least one jacks-or-better game outcome based jackpot standards element.

154. A game device to achieve extended player retention comprising:
a. a game generator capable of providing a particular card game process to a player wherein said card game process has at least a queens-or-better game outcome;
b. a player interaction element through which said player can participate in said card game process;
c. at least one queens-or-better game outcome based jackpot standards element responsive to said card game process;
d. a player jackpot status display responsive to said at least one queens-or-better game outcome based jackpot standards element; and
e. a jackpot payout element responsive to said at least one queens-or-better game outcome based jackpot standards element.

155. A game device to achieve extended player retention comprising:
a. a game generator capable of providing a particular card game process to a player wherein said card game process has at least a kings-or-better game outcome;
b. a player interaction element through which said player can participate in said card game process;
c. at least one kings-or-better game outcome based jackpot standards element responsive to said card game process;
d. a player jackpot status display responsive to said at least one kings-or-better game outcome based jackpot standards element; and
e. a jackpot payout element responsive to said at least one kings-or-better game outcome based jackpot standards element.

156. A game device to achieve extended player retention comprising:
a. a game generator capable of providing a particular card game process to a player wherein said card game process has at least a aces-or-better game outcome;
b. a player interaction element through which said player can participate in said card game process;
c. at least one aces-or-better game outcome based jackpot standards element responsive to said card game process;
d. a player jackpot status display responsive to said at least one aces-or-better game outcome based jackpot standards element; and
e. a jackpot payout element responsive to said at least one aces-or-better game outcome based jackpot standards element.

157. A method of gaming to achieve extended player retention as described in claim 29, 31, 32, 35, 37, 56, 57, 58, 59, 60, 68 , 69, 70, 72, 74, 86, 91, 105, 107, 108, 109, 110, 111, 112, 121, 123, 125, 133, 134, 135, wherein said step of providing a particular game process to a player comprises the step of providing a card game process to a player and wherein said step of paying said player a jackpot amount comprises the step of paying said player a jackpot amount in said card game process.

158. A method of gaming to achieve extended player retention as described in claim 29, 31, 32, 35, 37, 56, 57, 58, 59, 60, 68, 69, 70, 72, 74, 86, 91, 105, 107, 108, 109, 110, 111, 112, 121, 123, 125, 133, 134, 135, wherein said step of providing a particular game process to a player comprises the step of providing an electronic card game process to a player and wherein said step of paying said player a jackpot amount comprises the step of paying said player a jackpot amount in said electronic card game process.

159. A method of gaming to achieve extended player retention as described in claim 29, 31, 32, 35, 37, 56, 57, 58, 59, 60, 68, 69, 70, 72, 74, 86, 91, 105, 107, 108, 109, 110, 111, 112, 121, 123, 125, 133, 134, 135, wherein said step of providing a particular game process to a player comprises the step of providing a keno game process to a player and wherein said step of paying said player a jackpot amount comprises the step of paying said player a jackpot amount in said keno game process.

160. A method of gaming to achieve extended player retention as described in claim 29, 31, 32, 35, 37, 56, 57, 58, 59, 60, 68, 69, 70, 72, 74, 86, 91, 105, 107, 108, 109, 110, 111, 112, 121, 123, 125, 133, 134, 135, wherein said step of providing a particular game process to a player comprises the step of providing an electronic keno game process to a player and wherein said step of paying said player a jackpot amount in said game process comprises the step of paying said player a jackpot amount in said electronic keno game process.

161. A method of gaming to achieve extended player retention as described in claim 29, 31, 32, 35, 37, 56, 57, 58, 59, 60, 68, 69, 70, 72, 74, 86, 91, 105, 107, 108, 109, 110, 111, 112, 121, 123, 125, 133, 134, 135, wherein said step of providing a particular game process to a player comprises the step of providing a slots game process to a player and wherein said step of paying said player a jackpot amount in said game process comprises the step of paying said player a jackpot amount in said slots game process.

162. A method of gaming to achieve extended player retention as described in claim 29, 31, 32, 35, 37, 56, 57, 58, 59, 60, 68, 69, 70, 72, 74, 86, 91, 105, 107, 108, 109, 110, 111, 112, 121, 123, 125, 133, 134, 135, wherein said step of providing a particular game process to a player comprises the step of providing an electronic slots game process to a player and wherein said step of paying said player a jackpot amount in said game process comprises the step of paying said player a jackpot amount in said electronic slots game process.

163. A method of gaming to achieve extended player retention as described in claim 162 wherein said step of providing an electronic slots game process to a player comprises the step of providing an electronic card game process to a player and wherein said step of paying said player a jackpot amount in said electronic slots game process comprises the step of paying said player a jackpot amount in said electronic card game process.

164. A method of gaming to achieve extended player retention as described in claim 56, 57, 58, 59, 60, 68, 69, 70, 72, 74, 86, 91, 105, 107, 108, 109, 110, 111, 112, 121, 122, 125, 133, 134, 135, 139, 140, 141, 142, 143, 144, 145, 146, 147, wherein said step of providing a particular game process to a player comprises the step of linking separate gaming machines.

165. A method of gaming to achieve extended player retention as described in claim 164 wherein said step of establishing at least one jackpot event in said game process comprises the step of establishing at least composite jackpot event in said game process.

166. A method of gaming to achieve extended player retention as described in claim 164 wherein said step of paying said player a jackpot amount comprises the step of paying all players on said linked gaming machines a portion of said jackpot amount.

167. A method of gaming to achieve extended player retention as described in claim 164 wherein said step of paying said player a jackpot amount comprises the step of paying selected players on said linked gaming machines a portion of said jackpot amount.

168. A method of gaming to achieve extended player retention as described in claim 167 wherein said step of paying selected players on said linked gaming machines a portion of said jackpot amount comprises the step of paying players selected from a group consisting of:
players having made a maximum bet,
players having made a maximum bet during some time period,
players having played a certain number of games,
players having played a certain number of games during some time period,
players having played 25 games,
players having played 50 games,
players having played 100 games,
players having played 250 games,
players having played 500 games,
players having played 1000 games,
players having played or played at a rate of 12 games during a 1 minute time period,
players having played or played at a rate of 75 games during a 10 minute time period,
players having played or played at a rate of 90 games during a 10 minute time period,
players having played or played at a rate of 80 games during a 20 minute time period,
players having played a certain dollar amount during some time period,
players having played a variable dollar amount in a unit period of time,
players having played an increasing dollar amount in a unit period of time as said jackpot event gets closer,
players having played a $25.00 amount,
players having played a $50.00 amount,
players having played a $100.00 amount,
players having played a $250.00 amount,
players having played a $500.00 amount,
players having played or played at a rate of a $50.00 amount during a 1 hour time period,
players having played or played at a rate of a $100.00 amount during a 1 hour time period,
players having played or played at a rate of a $250.00 amount during a 2 hour time period, and
players having played or played at a rate of a $500.00 amount during a 5 hour time period.

169. A method of gaming to achieve extended player retention as described in claim 164 wherein said step of paying said player a jackpot amount comprises the step of paying the player achieving a final step in said jackpot event on said linked gaming machines an entire jackpot amount.

170. A method of gaming to achieve extended player retention as described in claim 29, 31, 32, 35, 40, 41, 56, 57, 58, 59, 60, 68, 69, 70, 72, 74, 86, 91, 105, 107, 108, 109, 110, 111, 112, 121, 122, 125, 133, 134, 135, 139, 140, 141, 142, 143, 144, 145, 146, 147, wherein said step of paying said player a jackpot amount comprises the step of paying said player said jackpot amount if said player has accomplished a selected event.

171. A method of gaming to achieve extended player retention as described in claim 170 wherein said step of paying said player said jackpot amount if said player has accomplished a selected event comprises the step of determining if said player has achieved a selected event from a group consisting of:
having made a maximum bet,
having made a maximum bet during some time period,
having played a certain number of games,
having played a certain number of games during some time period,
having played 25 games,
having played 50 games,
having played 100 games,
having played 250 games,
having played 500 games,
having played 1000 games,
having played or played at a rate of 12 games during a 1 minute time period,
having played or played at a rate of 75 games during a 10 minute time period,
having played or played at a rate of 90 games during a 10 minute time period,
having played or played at a rate of 80 games during a 20 minute time period,
having played a certain dollar a mount during so me time period,
having played a variable dollar amount in a unit period of time,
having played an increasing dollar amount in a unit period of time as said jackpot event gets closer,
having played a $25.00 amount,
having played a $50.00 amount,
having played a $100.00 amount,
having played a $250.00 amount,
having played a $500.00 amount,
having played or played at a rate of a $50.00 amount during a 1 hour time period,
having played or played at a rate of a $100.00 amount during a 1 hour time period,
having played or played at a rate of a $250.00 amount during a 2 hour time period, and
having played or played at a rate of a $500.00 amount during a 5 hour time period.

172. A method of gaming to achieve extended player retention as described in any of the foregoing method of gaming claims and further comprising the step of retaining a profit remaining after payout of a winnings and said jackpot amount.

173. A game device to achieve extended player retention as described in claim 42, 44, 45, 48, 50, 62, 63, 64, 65, 66, 77, 78, 81, 83, 96, 101, 113, 115, 116, 117, 118, 119, 120, 127, 129, 131, 136, 137, 138, wherein said game generator capable of providing a particular game process to a player comprises a card game generator capable of providing a card game process to a player and wherein said jackpot standards element comprises a jackpot standards element responsive to said card game process.

174. A game device to achieve extended player retention as described in claim 42, 44, 45, 48, 50, 62, 63, 64, 65, 66, 77, 78, 81, 83, 96, 101, 113, 115, 116, 117, 118, 119, 120, 127, 129, 131, 136, 137, 138, wherein said game generator capable of providing a particular game process to a player comprises an electronic card game generator capable of providing an electronic card game process to a player and wherein said jackpot standards element comprises a jackpot standards element responsive to said electronic card game process.

175. A game device to achieve extended player retention as described in claim 42, 44, 45, 48, 50, 62, 63, 64, 65, 66, 77, 78, 81, 83, 96, 101, 113, 115, 116, 117, 118, 119, 120, 127, 129, 131, 136, 137, 138, wherein said game generator capable of providing a particular game process to a player comprises a keno game generator capable of providing a keno game process to a player and wherein said jackpot standards element comprises a jackpot standards element responsive to said card game process.

176. A game device to achieve extended player retention as described in claim 42, 44, 45, 48, 50, 62, 63, 64, 65, 66, 77, 78, 81, 83, 96, 101, 113, 115, 116, 117, 118, 119, 120, 127, 129, 131, 136, 137, 138, wherein said game generator capable of providing a particular game process to a player comprises an electronic keno game generator capable of providing an electronic keno game process to a player and wherein said jackpot standards element comprises a jackpot standards element responsive to said electronic keno game process.

177. A game device to achieve extended player retention as described in claim 42, 44, 45, 48, 50, 62, 63, 64, 65, 66, 77, 78, 81, 83, 96, 101, 113, 115, 116, 117, 118, 119, 120, 127, 129, 131, 136, 137, 138, wherein said game generator capable of providing a particular game process to a player comprises a slots game generator capable of providing a slots game process to a player and wherein said jackpot standards element comprises a jackpot standards element responsive to said slots game process.

178. A game device to achieve extended player retention as described in claim 42, 44, 45, 48, 50, 62, 63, 64, 65, 66, 77, 78, 81, 83, 96, 101, 113, 115, 116, 117, 118, 119, 120, 127, 129, 131, 136, 137, 138, wherein said game generator capable of providing a particular game process to a player comprises an electronic slots game generator capable of providing an electronic slots game process to a player and wherein said jackpot standards element comprises a jackpot standards element responsive to said electronic slots game process.

179. A game device to achieve extended player retention as described in claim MDa1 wherein said electronic slots game generator capable of providing an electronic slots game process to a player comprises an electronic card game generator capable of providing an electronic card game process to a player and wherein said jackpot standards element responsive to said electronic slots game process comprises a jackpot standards element responsive to said electronic card game process.

180. A game device to achieve extended player retention as described in claim 42, 62, 63, 64, 65, 66, 77, 78, 81, 83, 96, 101, 113, 115, 116, 117, 118, 119, 120, 127, 129, 131, 136, 137, 138, 148, 149, 150, 151, 152, 153, 154, 155, 156, and further comprising a separate machine link element which is responsive to multiple separate machines.

181. A game device to achieve extended player retention as described in claim 180 wherein said jackpot standards element comprises a composite jackpot event standards element.

182. A game device to achieve extended player retention as described in claim 180 wherein said jackpot payout element comprises an all players payout element.

183. A game device to achieve extended player retention as described in claim 180 wherein said jackpot payout element comprises a select players payout element.

184. A game device to achieve extended player retention as described in claim 183 wherein said select players payout element comprises a select players payout element which utilizes players selected from a group consisting of:
players having made a maximum bet,
players having made a maximum bet during some time period,
players having played a certain number of games,
players having played a certain number of games during some time period,
players having played 25 games,
players having played 50 games,
players having played 100 games,
players having played 250 games,
players having played 500 games,
players having played 1000 games,
players having played or played at a rate of 12 games during a 1 minute time period,
players having played or played at a rate of 75 games during a 10 minute time period,
players having played or played at a rate of 90 games during a 10 minute time period,
players having played or played at a rate of 80 games during a 20 minute time period,
players having played a certain dollar amount during some time period,
players having played a variable dollar amount in a unit period of time,
players having played an increasing dollar amount in a unit period of time as said jackpot event gets closer,
players having played a $25.00 amount,
players having played a $50.00 amount,
players having played a $100.00 amount,
players having played a $250.00 amount,
players having played a $500.00 amount,
players having played or played at a rate of a $50.00 amount during a 1 hour time period,
players having played or played at a rate of a $100.00 amount during a 1 hour time period,
players having played or played at a rate of a $250.00 amount during a 2 hour time period, and
players having played or played at a rate of a $500.00 amount during a 5 hour time period.

185. A game device to achieve extended player retention as described in claim 180 wherein said jackpot payout element comprises a player-achieving-a-final-step-takes-all jackpot payout element.

186. A game device to achieve extended player retention as described in claim 42, 44, 45, 48, 53, 54, 42, 62, 63, 64, 65, 66, 77, 78, 81, 83, 96, 101, 113, 115, 116, 117, 118, 119, 120, 127, 129, 131, 136, 137, 138, 148, 149, 150, 151, 152, 153, 154, 155, 156, wherein said jackpot payout element comprises a select player payout element.

187. A game device to achieve extended player retention as described in claim 186 wherein said select player payout element comprises a select player payout element which determines if a player has achieved an event selected from a group consisting of:
having made a maximum bet,
having made a maximum bet during some time period,
having played a certain number of games,
having played a certain number of games during some time period,
having played 25 games,
having played 50 games,
having played 100 games,
having played 250 games,
having played 500 games,
having played 1000 games,
having played or played at a rate of 12 games during a 1 minute time period,
having played or played at a rate of 75 games during a 10 minute time period,
having played or played at a rate of 90 games during a 10 minute time period,
having played or played at a rate of 80 games during a 20 minute time period,
having played a certain dollar amount during some time period,
having played a variable dollar amount in a unit period of time,
having played an increasing dollar amount in a unit period of time as said jackpot event gets closer,
having played a $25.00 amount,
having played a $50.00 amount,
having played a $100.00 amount,
having played a $250.00 amount,
having played a $500.00 amount,
having played or played at a rate of a $50.00 amount during a 1 hour time period,
having played or played at a rate of a $100.00 amount during a 1 hour time period,
having played or played at a rate of a $250.00 amount during a 2 hour time period, and
having played or played at a rate of a $500.00 amount during a 2 hour time period.

188. A game device to achieve extended player retention as described in any of the foregoing game device claims and further comprising a profit retainer which is responsive to a remaining amount after payout of a winnings and said jackpot amount.
